(19) United States
(12) Patent Application Publication
(10) Pub. No.: US 2016/0039188 A1
(43) Pub. Date: Feb. 11, 2016

(54) TRANSFER MATERIAL, SUBSTRATE WITH TRANSFER LAYER, TOUCH PANEL, MANUFACTURING METHODS THEREFOR, AND INFORMATION DISPLAY DEVICE

(71) Applicant: FUJIFILM Corporation, Tokyo (JP)

(72) Inventor: Hitoshi NAMIKAWA, Fujinomiya-shi (JP)

(73) Assignee: FUJIFILM CORPORATION, Tokyo (JP)

(21) Appl. No.: 14/918,683

(22) Filed: Oct. 21, 2015

Related U.S. Application Data
(63) Continuation of application No. PCT/JP2014/061375, filed on Apr. 23, 2014.

(30) Foreign Application Priority Data
Apr. 26, 2013 (JP) 2013-094109

(51) Int. Cl. B32B 27/08; B32B 23/08; B32B 38/10; B32B 27/28; B32B 7/06; B32B 27/18; B32B 27/36; B32B 27/32

(52) U.S. Cl. CPC B32B 27/08; B32B 27/365; B32B 27/36; B32B 23/08; B32B 27/32; B32B 27/283; B32B 7/06; B32B 27/18; B32B 38/10; B32B 2307/748; B32B 2457/208; B32B 2255/26; B32B 2457/20; B32B 2255/10; B32B 2309/02

(57) ABSTRACT

The transfer material includes a temporary support, a release layer, a transfer layer, and a protective film in this order. When the protective film is peeled off from the transfer material, the protective film is peeled off from the transfer layer, and the transfer layer remains on the release layer side. In addition, when the temporary support is peeled off after the transfer layer is transferred to a transfer target substrate which is formed of glass or a film selected from TAC, PET, PC, or COP, the release layer is present on the peeled temporary support side.

### CROSS-REFERENCE TO RELATED APPLICATIONS

This application is a Continuation of PCT International Application No. PCT/JP2014/61375, filed on Apr. 23, 2014, which claims priority under 35 U.S.C. §119(a) to Japanese Patent Application No. 2013-094109, filed on Apr. 26, 2013. Each of the above application(s) is hereby expressly incorporated by reference, in its entirety, into the present application.

### BACKGROUND OF THE INVENTION

The present invention relates to: a transfer material and a manufacturing method therefor; a substrate with a transfer layer in which the transfer material is used and a manufacturing method therefor; a touch panel including the substrate with a transfer layer and a manufacturing method therefor; and an information display device including the touch panel.

### DESCRIPTION OF THE RELATED ART

Recently, an electronic apparatus such as a mobile phone, a car navigation device, a personal computer, a ticket vending machine, or a bank terminal has been used in which a touch panel type input device is arranged on a surface of a liquid crystal device or the like. In the touch panel type input device, while referring to an instruction image displayed on an image display region of a liquid crystal device, a portion where the instruction image is displayed is touched by a finger, a touch pen, or the like such that information corresponding to the instruction image is input thereto.

Examples of such an input device (touch panel) include a resistive input device and a capacitive input device. The capacitive input device has an advantageous effect in that a translucent conductive film only has to be formed on a single substrate. In the capacitive input device, in order for the user not to visually recognize a routing circuit or the like of a display device and to enhance the appearance of the display device, a decorative material is arranged for decoration in a frame surrounding an information display portion (image display portion) which is touched by a finger or a touch pen.

In technical fields other than the manufacturing of a touch panel, a method for forming a desired layer using a transfer material is known. For example, JP2011-095716A discloses a method including: transferring a photosensitive transfer material to a permanent support, the photosensitive transfer material being obtained by providing a thermoplastic resin layer (cushioning layer), an interlayer (oxygen barrier layer), and a photosensitive color composition layer on a temporary support and further providing a cover sheet on the photosensitive color composition layer; peeling off and removing the temporary support from the oxygen barrier layer; forming a laminate in which the permanent support, the photosensitive color resin composition layer, and the oxygen barrier layer are formed in this order; and exposing and developing the laminate such that a colorant layer is formed on the permanent support excluding the thermoplastic resin layer and the interlayer.

In addition, JP2012-121969A discloses a release film including a temporary support and a release layer. JP2012-121969A describes that a transfer film including a decorative layer such as a pattern layer or an adhesion layer is formed on the release layer surface of the release film. However, in JP2012-121969A, neither an example of manufacturing the transfer film nor an example of transferring the decorative layer or the like using the transfer film are described, and a concurrent molding-transferring method (a method for removing a temporary support after in-mold transfer) is assumed as a transfer method.

### SUMMARY OF THE INVENTION

The present inventors tried to form the decorative layer and the like using the transfer material during the manufacture of a touch panel. At this time, it was found that, in a case where the transfer material described in JP2011-095716A including the cushioning layer and the oxygen barrier layer on the temporary support is used, there is a problem in that, when the cover sheet is peeled off after the transfer of a transfer layer, the cushioning layer and the oxygen barrier layer remain on the transfer layer side. In JP2011-095716A, the cushioning layer and the oxygen barrier layer are removed by developing, but improvement is required from the viewpoint of reducing the manufacturing cost.

In addition, it was found that, in a case where a transfer material in which a transfer layer is provided on a temporary support without providing a cushioning layer and an oxygen barrier layer is used, when the temporary support is peeled off after the transfer of the transfer layer, there is a problem in that a part of the transfer layer remains on the temporary support or the inside of the transfer layer is damaged.

It was found that, in a case where a protective film is not provided on a transfer layer, during the storage of a transfer material in a roll shape, there is a problem in that the transfer layer cannot be transferred to deteriorate transfer characteristics because a part of the transfer layer is adhered to a back surface of a temporary support. In addition, it was found that, even in a case where a protective film is provided on a transfer layer, unless the peeling strength between the protective film and another layer is adjusted, there is a problem in that, the transfer layer cannot be transferred to deteriorate transfer characteristics because a part of the transfer layer is adhered to the protective film side during the peeling of the protective film.

An object of the present invention is to provide: a transfer material in which the transfer characteristics of a transfer layer are superior and the remaining of a non-peeled portion on a transferred transfer layer is suppressed; a substrate with a transfer layer; a touch panel; manufacturing methods therefor; and an information display device.

As a result of thorough investigation for achieving the above-described object, the present inventors found that a transfer material in which the transfer characteristics of a transfer layer are superior and the remaining of a non-peeled portion on a transferred transfer layer is suppressed can be obtained by adopting a structure in which a temporary support, a release layer, a transfer layer, and a protective film are formed in this order and controlling the peeling strength between the respective layers to satisfy a specific relationship.

That is, the present inventors found that the above-described object can be achieved when the present invention adopts the following configuration, thereby completing the present invention.

[1] A transfer material including a temporary support, a release layer, a transfer layer, and a protective film in this order,

in which when the protective film is peeled off from the transfer material, the protective film is peeled off from the transfer layer and the transfer layer remains on the release layer side, and

when the temporary support is peeled off after the transfer layer is transferred to a transfer target substrate formed of glass or to a transfer target substrate formed of a film selected from TAC, PET, PC, and COP, the release layer is peeled off together with the temporary support.

[2] In The transfer material according to [1], it is preferable that, when the protective film is peeled off from the transfer material, a peeling strength between the protective film and the transfer layer is 10 mN/m to 200 mN/m. [3] In the transfer material according to [1] or [2], it is preferable that, when a laminate including the release layer and the temporary support is peeled off from the transfer layer which is transferred to the transfer target substrate, a peeling strength is 40 mN/m to 400 mN/m.

[4] In the transfer material according to any one of [1] to [3], it is preferable that the release layer contains a matting agent and that the matting agent protrudes from the release layer by 150 nm to 500 nm. [5] In the transfer material according to any one of [1] to [4], it is preferable that the release layer contains a polymer selected from a polycondensate of alkyl diol and bifunctional or higher isocyanate, a silicone resin, and an olefin resin.

[6] In the transfer material according to any one of [1] to [5], it is preferable that the release layer contains a polymer selected from a polycondensate of alkyl diol and bifunctional or higher isocyanate and an olefin resin.

[7] In the transfer material according to any one of [1] to [6], it is preferable that the transfer layer includes at least one layer and that at least one layer of the transfer layer contains a binder resin and at least one of a pigment and a dye.

[8] In the transfer material according to any one of [1] to [7], it is preferable that the transfer layer includes at least two layers, that at least one layer of the transfer layer contains a binder resin and at least one of a pigment and a dye, and that another layer of the transfer layer contains a binder resin.

[9] In the transfer material according to [7] or [8], it is preferable that the binder resin contained in the at least one layer of the transfer layer has a siloxane bond.

[10] In the transfer material according to any one of [7] to [9], it is preferable that at least one layer of the transfer layer contains, as the pigment or the dye, at least one pigment or dye selected from a black pigment, a black dye, and a white pigment.

[11] In the transfer material according to any one of [1] to [10], it is preferable that the transfer layer includes at least two layers, that a layer of the transfer layer adjacent to the release layer contains at least one pigment or dye selected from a black pigment and a black dye, and that a layer of the transfer layer adjacent to the protective film contains a white pigment.

[12] In the transfer material according to any one of [1] to [11], it is preferable that the transfer layer includes at least two layers and that an optical density of a layer of the transfer layer adjacent to the release layer is higher than that of a layer of the transfer layer adjacent to the protective film.

[13] In the transfer material according to any one of [1] to [12], it is preferable that the transfer layer includes at least two layers and that an optical density of a layer of the transfer layer adjacent to the release layer is 1.0 to 6.0.

[14] In the transfer material according to any one of [1] to [13], it is preferable that the transfer layer includes at least two layers and that a thickness of a layer of the transfer layer adjacent to the release layer is 0.5 μm to 3.0 μm.

[15] In the transfer material according to any one of [1] to [14], it is preferable that the transfer layer includes at least two layers and that a thickness of a layer of the transfer layer adjacent to the protective film layer is 5.0 μm to 50.0 μm.

[16] In the transfer material according to any one of [1] to [15], it is preferable that the temporary support contains a resin selected from a polyester resin, a triacyl cellulose resin, and a cycloolefin resin.

[17] In the transfer material according to any one of [1] to [16], it is preferable that the protective film is a polyolefin film.

[18] In the transfer material according to any one of [1] to [17], it is preferable that the transfer target substrate is formed of glass.

[19] In the transfer material according to any one of [1] to [17], it is preferable that the transfer target substrate is formed of a cycloolefin polymer film.

[20] A method for manufacturing the transfer material according to any one of [1] to [19], the method including the following steps (1) to (3):

(1) preparing the temporary support with the release layer;

(2) forming the transfer layer on the release layer side of the temporary support; and

(3) bonding the protective film to the transfer layer side.

[21] A method for manufacturing a substrate with a transfer layer using the transfer material according to any one of [1] to [19], the method including the following steps of:

(11) peeling off the protective film from the transfer material;

(12) transferring the transfer layer side of the transfer material to the transfer target substrate formed of glass or to the transfer target substrate formed of a film selected from TAC, PET, PC, and COP; and

(13) simultaneously peeling off the release layer and the temporary support from the transfer layer.

[22] In the method for manufacturing a substrate with a transfer layer according to [21], it is preferable that, when the transfer layer is transferred to the transfer target substrate, a temperature of the transfer target substrate is 40° C. to 150° C.

[23] A substrate with a transfer layer which is manufactured using the method for manufacturing a substrate with a transfer layer according to [21] or [22].

[24] In the substrate with a transfer layer according to [23], it is preferable that a surface resistance of the transfer layer at 25° C. is 1.0×10¹⁰∥ or higher.

[25] A method for manufacturing a touch panel using the substrate with a transfer layer according to [23] or [24], the method including the following steps of:

(21) forming a conductive layer on the transfer layer side of the substrate with a transfer layer; and

(22) removing a part of the conductive layer to form an electrode pattern.

[26] A touch panel including the substrate with a transfer layer according to [23] or [24].

[27] An information display device comprising the touch panel according to [26].

According to the present invention, it is possible to provide: a transfer material in which the transfer characteristics of a transfer layer are superior and the remaining of a non-peeled portion on a transferred transfer layer is suppressed; a substrate with a transfer layer; a touch panel; manufacturing methods therefor; and an information display device.

### BRIEF DESCRIPTION OF THE DRAWINGS

FIG. 1A is a cross-sectional view schematically showing a configuration of an example of a touch panel according to the present invention.

FIG. 1B is a cross-sectional view schematically showing a configuration of another example of the touch panel according to the present invention.

FIG. 2 is a diagram showing an example of a front surface plate of the touch panel.

FIG. 3 is a diagram showing an example of a first transparent electrode pattern and a second transparent electrode pattern.

FIG. 4 is a top view showing an example of tempered glass on which an opening is formed.

FIG. 5 is a top view showing an example of a front surface plate on which a white layer and a light shielding layer are formed.

FIG. 6 is a top view showing an example of a front surface plate on which a first transparent electrode pattern is formed.

FIG. 7 is a top view showing an example of a front surface plate on which first and second transparent electrode patterns are formed.

FIG. 8 is a top view showing an example of a front surface plate on which another conductive element is further formed in addition to the first and second transparent electrode patterns.

FIG. 9 is a schematic diagram showing an example of a cross-section of a transfer material.

FIG. 10 is a schematic diagram showing an example of a cross-section of the transfer material when a protective film is peeled off from the transfer material.

FIG. 11 is a schematic diagram showing an example of a cross-section of the transfer material when a transfer layer of the transfer material is transferred to a transfer target substrate.

FIG. 12 is a schematic diagram showing a cross-section of the transfer material when a temporary support and a release layer are simultaneously peeled off from the transfer material after the transfer layer of the transfer material is transferred to the transfer target substrate.

FIG. 13 is a schematic diagram showing an example of a half-cutting method.

### DESCRIPTION OF THE PREFERRED EMBODIMENTS

Hereinafter, a transfer material, a substrate with a transfer layer, a touch panel, manufacturing methods therefor, and an information display device according to the present invention will be described in detail.

The following description of constituent elements is based on a representative embodiment of the present invention. The present invention is not limited to the following embodiment. In this specification, numerical ranges represented by “to” include numerical values before and after “to” as lower limits and upper limits.

[Transfer Material]

The transfer material includes a temporary support, a release layer, a transfer layer, and a protective film in this order. When the protective film is peeled off from the transfer material, the protective film is peeled off from the transfer layer, and the transfer layer remains on the release layer side. In addition, when the temporary support is peeled off after the transfer layer is transferred to a transfer target substrate which is formed of glass or a film selected from TAC, PET, PC, or COP, the release layer is present on the peeled temporary support side.

With such a configuration, the transfer characteristics of the transfer layer are superior, the peeling of the transfer layer is prevented, and the release layer does not remain on the transfer layer side; as a result, a developing step is not necessary.

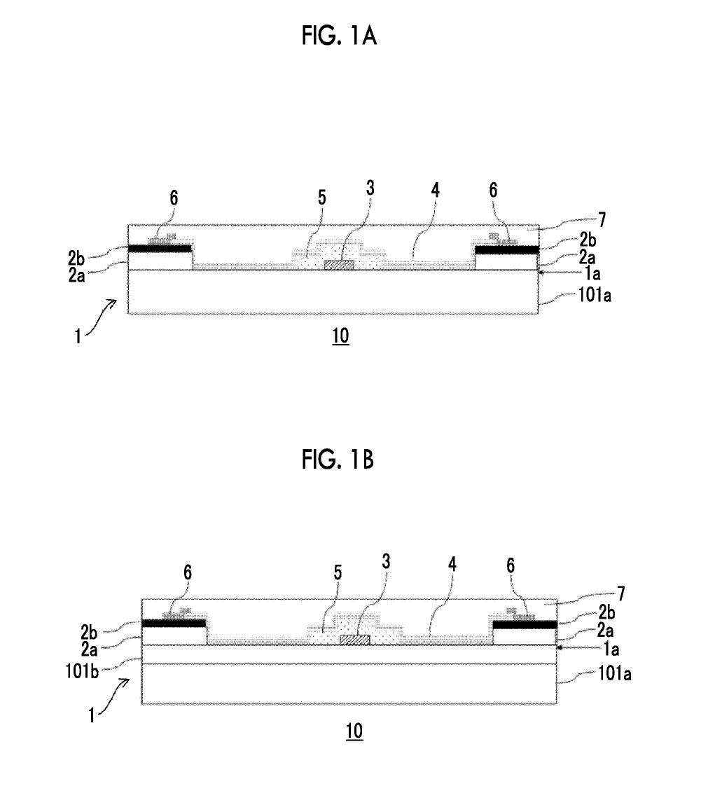

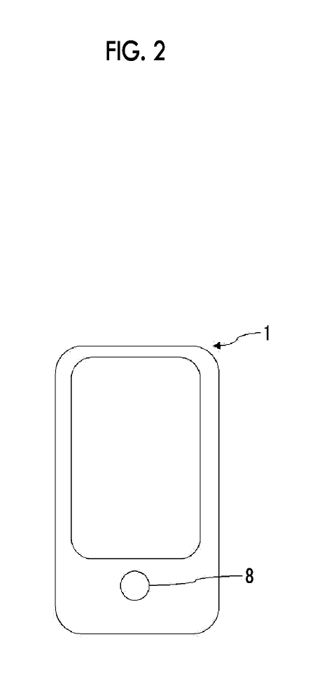

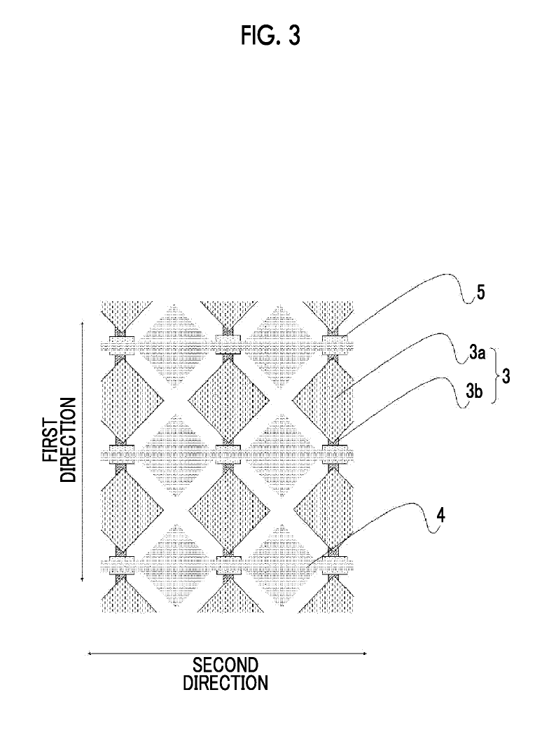

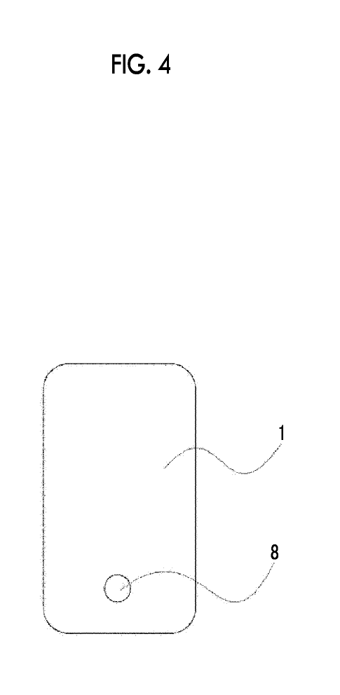

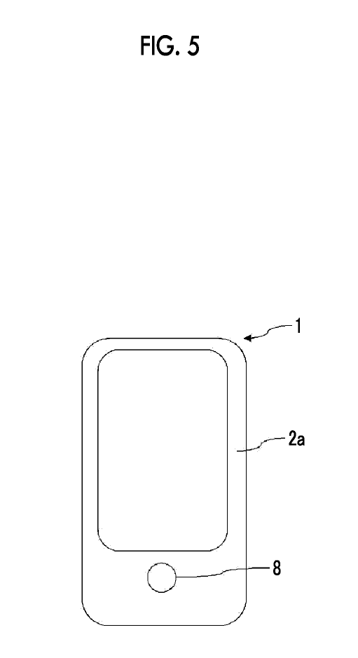

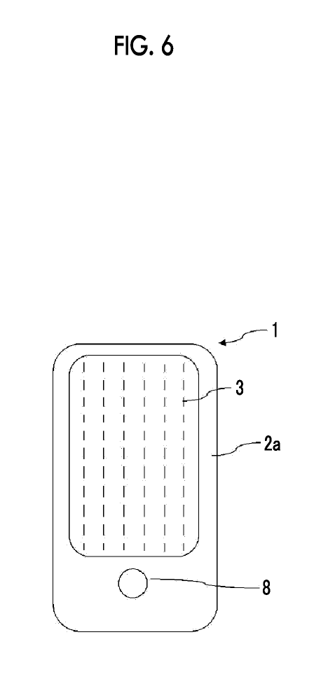

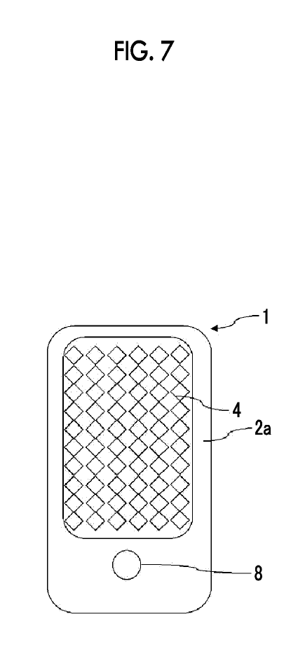

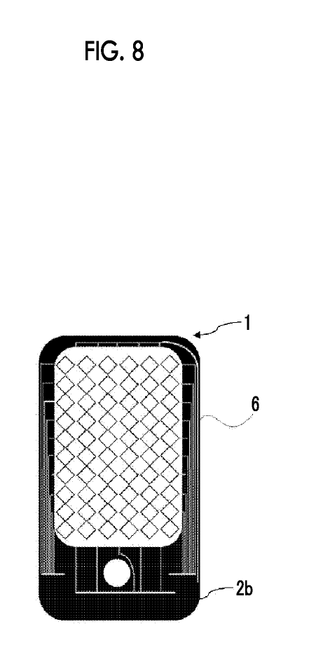

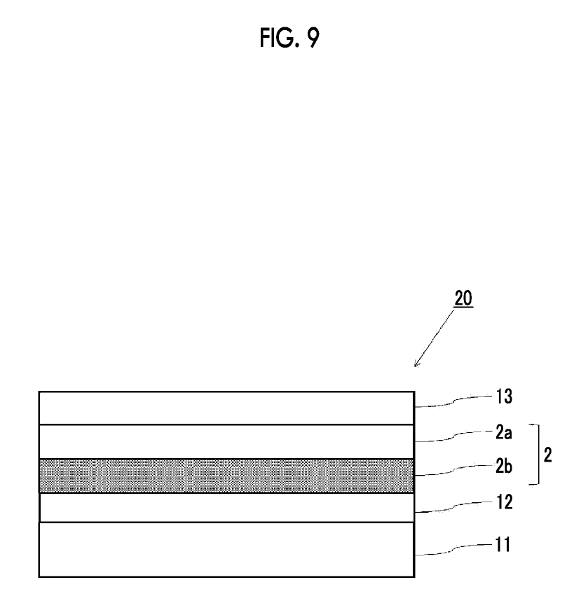

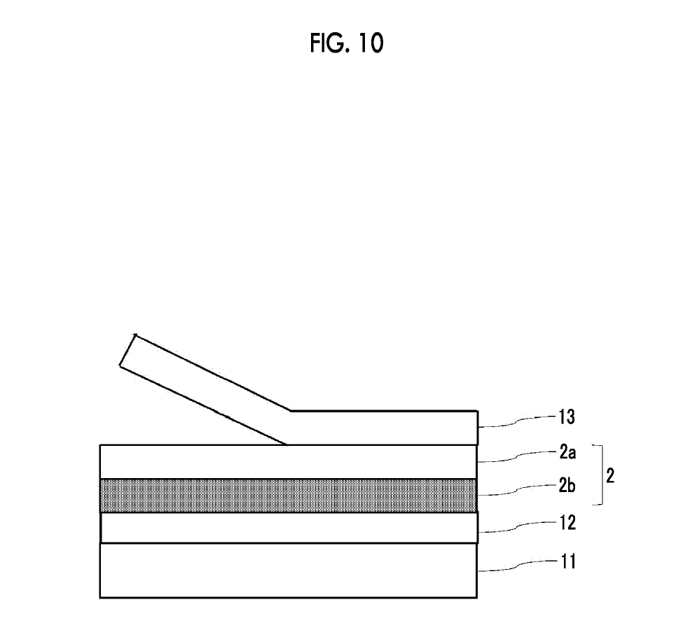

In a touch panel 10 which is a capacitive input device having an opening 8 (refer to FIG. 2), when a white layer 2a, a light shielding layer 2b, and the like (refer to FIGS. 1A and 1B) are formed using a transfer material 20 (refer to FIG. 9), the leaking of a resist component from the opening 8 is suppressed even on a front surface plate 1 which is a transfer target substrate having the opening 8. In particular, in the white layer 2a and the light shielding layer 2b where a light shielding pattern is necessarily formed on a region close to the boundary with the front surface plate 1, the protrusion of the resist component from a glass end is suppressed. Therefore, the touch panel 10 having advantageous effects in terms of a reduction in thickness and weight can be manufactured through a simple process without contamination of the back side of the front surface plate.

The front surface plate 1 as the transfer target substrate is formed of at least one of a glass substrate 101a (cover glass) and a film substrate 101b. In FIG. 1A, the front surface plate 1 is formed of the glass substrate 101a. In FIG. 1B, the front surface plate 1 is formed of the glass substrate 101a and the film substrate 101b. For example, the film substrate 101b is formed of a film selected from triacetyl cellulose (TAC), polyethylene terephthalate (PET), polycarbonate (PC), and a cycloolefin polymer (COP).

Hereinafter, a preferable embodiment of the transfer material according to the present invention will be described.

<Configuration>

First, a configuration of the transfer material 20 will be described.

FIG. 9 shows an example of the preferable embodiment of the transfer material according to the present invention. The transfer material 20 includes a temporary support 11, a release layer 12, a transfer layer 2 including the light shielding layer 2b and the white layer 2a, and a protective film 13 in this order. The transfer material 20 is formed by laminating the temporary support 11, the release layer 12, the transfer layer 2, and the protective film 13 in this order.

In the transfer material 20 having the above-described configuration, when the temporary support 11 is peeled off after the transfer layer 2 is transferred to the glass substrate 101a or to the film substrate 101b selected from TAC, PET, PC, or COP, the release layer 12 is present on the peeled temporary support 11.

<Peeling Strength Between Layers>

It is preferable that the peeling strength between the protective film 13 and the transfer layer 2 is lower than the peeling strength between the transfer layer 2 and the release layer 12. That is, the protective film 13 is more likely to be peeled off from the transfer layer 2 than the release layer 12. When the relationship between the peeling strengths is reversed, peeling occurs between the release layer 12 and the transfer layer 2, and a preferable embodiment cannot be obtained.

It is preferable that the peeling strength between the protective film 13 and the transfer layer 2 is within a range of 10 mN/m to 200 mN/m. When the peeling strength is lower than 10 mN/m, the protective film 13 is unnecessarily likely to be peeled off from the transfer material 20 during handling, which is not preferable. In addition, when the peeling strength is higher than 200 mN/m, during the peeling of the protective film 13, peeling may occur between the transfer layer 2 and the release layer 12, or the transfer layer 2 may be adhered to the protective film 13 through cohesion failure, which is not preferable.

The peeling strength between the protective film 13 and the transfer layer 2 is more preferably 15 mN/m to 150 mN/m, still more preferably 20 mN/m to 100 mN/m, and even still more preferably 30 mN/m to 60 mN/m.

When a laminate including the release layer 12 and the temporary support 11 is peeled off from the transfer layer 2 which is transferred to the transfer target substrate, the peeling strength is preferably 40 mN/m to 400 mN/m, more preferably 50 mN/m to 300 mN/m, and still more preferably 60 mN/m to 250 mN/m. In a case where the peeling strength is within this range, when the temporary support 11 is peeled off after the transfer layer 2 is transferred to the glass substrate 101a or to the film substrate 101b, the release layer 12 is likely to be present on the peeled temporary support 11 side.

<Temporary Support>

The transfer material 20 includes the temporary support 11.

It is preferable that the temporary support 11 is flexible. In addition, it is preferable that the temporary support 11 is not significantly modified, expanded, or contracted even under pressure or under pressure and heat. Examples of the temporary support 11 include a polyethylene terephthalate film, a cellulose triacetate film, a polystyrene film, and a polycarbonate film. It is preferable that the temporary support 11 includes a resin selected from a polyester resin, a triacyl cellulose resin, and a cycloolefin resin. In particular, it is more preferable that the temporary support 11 includes a biaxially stretched polyethylene terephthalate film.

The thickness of the temporary support 11 is not particularly limited, but is preferably 5 μm to 300 μm and more preferably 20 μm to 200 μm.

The temporary support 11 may be transparent and may contain, for example, dyed silicon, an alumina sol, a chromium salt, or a zirconium salt.

Using a method described in JP2005-221726A, conductivity may be imparted to the temporary support 11.

<Release Layer>

The transfer material 20 includes the release layer 12.

It is preferable that the release layer 12 contains a polymer selected from a polycondensate of alkyl diol and bifunctional or higher isocyanate, a silicone resin, and an olefin resin.

As the polycondensate of alkyl diol and bifunctional or higher isocyanate, a polycondensate of polyolefin polyol and bifunctional or higher isocyanate is preferable. As the polycondensate of polyolefin polyol and bifunctional or higher isocyanate, examples described in JP2012-162625A and JP2011-94096A can be used.

As the polyolefin polyol, the following products are preferable:
EPOL (manufactured by Idemitsu Kosan Co., Ltd.); and UNISTOLE P-801 (manufactured by Mitsui Chemicals, Inc.).

As the bifunctional or higher isocyanate, the following products are preferable:
CORONATE L, CORONATE HL, MILLIONATE MT (all of which are manufactured by Nippon Polyurethane Industry Co., Ltd.); and TAKENATE D110N (manufactured by Mitsui Chemicals, Inc.).

As the olefin resin, the following products are preferable:
TAFMER P-0080K, TAFMER P-0280, TAFMER A-35070S, TAFMER P-0680, TAFMER A-1070S, TAFMER A-4085S, and LUCANT HC-2000 (all of which are manufactured by Mitsui Chemicals, Inc.); and ENGAGE 8180 (manufactured by Dow Chemical Company).

As an acid-modified polyolefin resin, the following examples described in JP2011-126043A, JP2012-152965A, and JP2012-171153A can be used.

As the acid-modified polyolefin resin, the following products are preferable:
POLYVEST OC800S (manufactured by Evonik Degussa Gmbh); KURAPRENE LIR-403 and LIR-410 (both of which are manufactured by Kuraray Co., Ltd.); BONDINE LX-4110, HX-8210, and HX-8290 (all of which are manufactured by Arkema K.K.); and products obtained by modifying VESTOPLAST 708 and VESTOPLAST 408 (both of which are manufactured by Huels Japan Ltd.) with maleic anhydride.

In the transfer material 20, “release film” in which the release layer 12 is formed on at least one surface of the temporary support 11 may be used as the temporary support 11 and the release layer 12.

It is preferable that the release layer 12 used in the release film contains, as a major component, one or more resins selected from a silicone resin and a fluororesin.

As the silicone resin, a silicone resin which is generally used as a release agent can be used. The silicone resin selected from silicone resins which are generally used in the related art described in “Silicon Material Handbook” (edited by Dow Corning Corporation; August, 1993) can be used. In general, a thermosetting silicone resin or an ionizing radiation curable silicone resin (including a resin and a resin composition) is used. As the thermosetting silicone resin, for example, a condensation reaction type or addition reaction type silicone resin can be used. As the ionizing radiation curable silicone resin, an UV curable or electron beam curable silicone resin can be used. The above-described components are applied to a film which is the substrate, and then are dried or cured, thereby forming the release layer.

The polymerization degree of the curable silicone resin after curing is preferably about 50 to 200,000 and more preferably 1,000 to 100,000. Specific examples of a silicon resin having such a polymerization degree include the following resins: KS-718, KS-774, KS-775, KS-778, KS-779H, KS-830, KS-835, KS-837, KS-838, KS-839, KS-841, KS-843, KS-847, KS-847H, X-62-2418, X-62-2422, X-62-2125, X-62-2492, X-62-2494, X-62-5048, X-62-470, X-62-2366, X-62-630, X-92-140, X-92-128, KS-723A•B, KS-705F, KS-708A, KS-883, KS-709, and KS-719 manufactured by Shin-Etsu Chemical Co., Ltd.; TPR-6701, TPR-6702, TPR-6703, TPR-3704, TPR-6705, TPR-6721, TPR-6722, TPR-6700, XSR-7029, YSR-3022, and YR-3286 manufactured by Ge Toshiba Silicones Co., Ltd.; DK-Q3-202, DK-Q3-203, DK-Q3-204, DK-Q3-205, DK-Q3-210, DK-Q3-240, DK-Q3-3003, DK-Q3-3057, and SFXF-2560 manufactured by Dow Corning Corporation; SD-7226, SD-7229, SD-7320, BY-24-900, BY-24-171, BY-24-312, BY-24-374, SRX-375, SYL-OFF23, SRX-244, and SEX-290 manufactured by Dow Corning Corporation; and SILCOLEASE 425 manufactured by ICI Japan Ltd. Further, silicone resins described in, for example, JP1972-34447A (JP-S47-34447A) and JP1977-40918A (JP-552-40918A) can be used. Among these curable silicone resins, one kind may be used alone, or two or more kinds may be used in combination.

As the fluororesin, a fluororesin which is generally used as a release agent can be used. Examples of the fluororesin include a polymer (including an oligomer) or a copolymer of fluorine-containing polymerizable vinyl monomers, a copolymer of a fluorine-containing polymerizable vinyl monomer and a polymerizable vinyl monomer containing no fluorine atoms, and a resin which is a mixture of the above polymers containing 5 mol % to 80 mol % of fluorine atoms.

As a commercial product of the release film including the temporary support 11 and the release layer 12, for example, UNIPEEL TR4, TR6, and TR9 (all of which are manufactured by Unitika Ltd.); 6501 and 6502 (both of which are manufactured by Lintec Corporation); CERAPEEL BLK (manufactured by Toray Advanced Film Co., Ltd.); HP-A3 and HP-A5 (both of which are manufactured by Fujico Co., Ltd.); NSD (manufactured by Fujimori Kogyo Co., Ltd.); and TN110 (manufactured by Toyobo Co., Ltd.) can be preferably used.

In addition to the above-described resin, the release layer 12 may contain additives which are used in the related art within a range where the effects of the present invention do not deteriorate. Examples of the additives include a matting agent, a defoaming agent, a coating property improver, a thickener, an antistatic agent, an antioxidant, an ultraviolet absorber, a magnetizing agent, and a dye.

The release layer 12 contains a matting agent to prevent blocking when being in a roll shape. For example, the matting agent can be selected from a matting agent formed of a (meth)acrylic polymer and a matting agent formed of silica according to the intended use of the present invention. It is preferable that the matting agent has an average particle size of 100 nm to 1000 nm. When the average particle size is small, the blocking preventing effect may be insufficient. When the average particle size is large, a stain of the matting agent remains in the transfer layer 2, which may cause deterioration in the quality of the transfer material 20.

The release layer 12 contains the matting agent, and the matting agent protrudes from the release layer 12 by preferably 150 nm to 500 nm, more preferably 200 nm to 400 nm, and still more preferably 200 nm to 350 nm and even still more preferably 200 nm to 300 nm. Within this range, the blocking preventing effect can be obtained, and a stain of the matting agent can be prevented from remaining on the transfer layer 2 of the transfer material 20.

The amount of the matting agent protruding from the release layer 12 can be obtained from a value of surface roughness of the release layer 12 which is measured using an optical measuring instrument “Zygo New View 6200”. The height of the protrusion of the matting agent from the release layer in Examples described below was measured using the same method.

<Transfer Layer>

(Layer Configuration)

The transfer material 20 may include the transfer layer 2 including only one layer or the transfer layer 2 including at least two layers. That is, the transfer layer 2 may include one layer or two or more layers.

It is preferable that at least one layer of the transfer layer 2 contains a binder resin and at least one of a pigment and a dye. Among the layers of the transfer layer 2, the layer containing at least one of a pigment and a dye will also be referred to as “colorant layer”.

It is more preferable that the transfer layer 2 includes at least two layers, that at least one layer of the transfer layer 2 contains a binder resin and at least one of a pigment and a dye, and that another layer of the transfer layer 2 contains a binder resin.

It is still more preferable that at least one layer of the transfer layer 2 contains, as the pigment or the dye, at least one selected from a black pigment, a black dye, and a white pigment.

It is even still more preferable that the transfer layer 2 includes at least two layers, that a layer of the transfer layer 2 adjacent to the release layer 12 contains at least one selected from a black pigment and a black dye, and that a layer of the transfer layer 2 adjacent to the protective film 13 contains a white pigment.

Hereinafter, a case where the transfer layer 2 contains the colorant layer will be described, but the present invention is not limited thereto.

It is preferable that the transfer material 20 contains at least one of the light shielding layer 2b and the white layer 2a (hereinafter, collectively referred to as “colorant layer”).

By transferring the light shielding layer 2b and the white layer 2a, which are contained in the transfer material 20, to the front surface plate 1, a decorative layer (light shielding layer 2b and white layer 2a) of the “substrate with a transfer layer” can be formed.

(Material of Colorant Layer)

The colorant layer 2a contains: a colorant; and a binder resin for forming the colorant layer with the colorant. In addition, depending on the usage environment and the intended use, it is preferable that the colorant layer further contains a polymerizable compound and a polymerization initiator. In addition, the colorant layer can contain an antioxidant and a polymerization inhibitor.

It is preferable that the transfer material 20 includes the light shielding layer 2b and the white layer 2a as the transfer layer 2. It is preferable that the light shielding layer 2b and the white layer 2a in the transfer material 20 have the same compositions as those of the light shielding layer 2b and the white layer 2a included in the decorative layer in the substrate with a transfer layer. However, the light shielding layer 2b and the white layer 2a in the transfer material 20 may have different compositions depending on manufacturing steps after the transfer to the front surface plate 1. For example, when the light shielding layer 2b and the white layer 2a in the transfer material 20 contain a polymerizable compound, the content ratio of the polymerizable compound in the light shielding layer 2b and the white layer 2a included in the decorative layer in the substrate with a transfer layer may be changed.

Colorant: —Layer of Transfer Layer Adjacent to Protective Film, White Layer—

It is more preferable that the white layer 2a contains a white pigment.

Since the white layer 2a looks particularly conspicuous, it is preferable that the following colorant for the white layer 2a is used. As the colorant for the white layer 2a, a pigment is preferable and an inorganic white pigment is more preferable.

As the inorganic white pigment, a white pigment described in paragraphs [0015] and of JP2005-7765A can be used.

Specifically, as the inorganic white pigment, titanium oxide, zinc oxide, lithopone, precipitated calcium carbonate, white carbon, aluminum oxide, aluminum hydroxide, or barium sulfate is preferable; and titanium oxide or zinc oxide is more preferable. The white layer 2a is formed of preferably titanium oxide, more preferably a rutile type or anatase type titanium oxide, and still more preferably a rutile type titanium oxide.

The surface of titanium oxide can be treated with silica, alumina, titania, zirconia, an organic material, or a combination thereof.

As a result, the catalytic activity of titanium oxide can be suppressed, and heat resistance, light resistance, and the like can be improved.

From the viewpoint of suppressing the b value of the white layer 2a after heating, the surface of titanium oxide is preferably treated with alumina or zirconia and is more preferably treated with a combination of alumina and zirconia.

The content of the inorganic white pigment with respect to the total solid content of the white layer 2a is preferably 20 mass % to 75 mass %, more preferably 25 mass % to 60 mass %, and still more preferably 30 mass % to 50 mass %. When the content of the inorganic white pigment is within the above-described range, the brightness and whiteness after the same degree of heating as in a case of vapor-depositing a conductive layer by sputtering are within a favorable range (b value is low), and a decorative material which simultaneously satisfies other requirements can be formed.

“Total solid content” refers to the total mass of non-volatile components in the white layer 2a from which a solvent and the like are excluded.

It is preferable that the inorganic white pigment is used in the form of a dispersion (the same shall be applied to other pigments used in the light shielding layer 2b). This dispersion can be prepared by mixing the inorganic white pigment with a pigment dispersant to obtain a composition in advance, adding the composition to an organic solvent (or a vehicle), and dispersing the composition therein. “Vehicle” refers to, when a coating is liquid, a portion of a medium in which a pigment is dispersed, and contains: a liquid component (binder) which binds to the pigment to form a coating film; and a component (organic solvent) which dilutes the liquid component with a solvent.

A disperser which disperses the inorganic white pigment is not particularly limited, and examples thereof include well-known dispersers described in “Encyclopedia of Pigments” (Kunizo ASAKURA, first edition, published by Asakura Publishing Co., Ltd. 2000, p. 438), for example, a kneader, a roll mill, an attritor, a super mill, a dissolver, a homomixer and a sand mill. Further, the inorganic white pigment may be pulverized through a friction force using mechanical attrition described on p. 310 of the same publication.

From the viewpoint of improving dispersion stability and hiding power, the average primary particle size of the inorganic white pigment (colorant for the white layer) is preferably 0.16 μm to 0.3 μm, more preferably 0.18 μm to 0.27 μm, and still more preferably 0.19 μm to 0.25 μm. When the average primary particle size is 0.16 μm or more, the hiding power is high, it is difficult to see an underlayer of the light shielding layer 2b, and an increase in viscosity is not likely to occur. On the other hand, when the average primary particle size is 0.3 μm or less, the whiteness is sufficiently high, and the hiding power is also high, and the surface shape when being applied is superior.

“Average primary particle size” refer to the diameter of a circle having the same area which is converted from an electron microscope image of a particle. “Number average particle size” refers to the average value of 100 particles when the average primary particle sizes of a large number of particles are obtained.

The average particle size in a dispersion or a coating liquid can be measured using a laser scattering HORIBAH (manufactured by Horiba Ltd.).

—Layer of Transfer Layer Adjacent to Release Layer, Light Shielding Layer—

As a colorant for the light shielding layer 2b, the light shielding layer 2b contains preferably a dye or a pigment, more preferably a pigment, and still more preferably a black pigment. Examples of the black pigment include carbon black, titanium black, titanium carbon, iron oxide, titanium oxide, and graphite. In the substrate with a transfer layer, it is preferable that the light shielding layer 2b contains at least one of titanium oxide and carbon black, and it is more preferable that the light shielding layer 2b contains carbon black.

Binder Resin:

The binder resin for the transfer layer 2 is not particularly limited, and a well-known one thereof can be used.

In the transfer material 20, it is preferable that the binder resin included in at least one layer of the transfer layer 2 has a siloxane bond, it is more preferable that the binder resin is a resin having a siloxane bond in the main chain thereof.

With the above-described configuration, in the transfer material 20, the b value of the white layer 2a after a high-temperature treatment is reduced. The resin having a siloxane bond in the main chain thereof is not likely to be decomposed even after a high-temperature treatment (for example, a treatment at 280° C. for 30 minutes). Therefore, the white layer 2a and the light shielding layer 2b in which the resin having a siloxane bond in the main chain thereof is used are not likely to be decomposed after a high-temperature treatment and have a low b value. In particular, in a case where both of the white layer 2a and the light shielding layer 2b contain the resin having a siloxane bond in the main chain thereof, the b value after a high-temperature treatment can be reduced as compared to a case where only the white layer 2a contains the resin having a siloxane bond in the main chain thereof.

The resin having a siloxane bond in the main chain thereof is not particularly limited, and a silicone resin is preferable.

As the silicone resin, a well-known one can be used. For example, a methyl-based straight silicone resin, a methyl phenyl-based straight silicone resin, an acrylic resin-modified silicone resin, a polyester resin-modified silicone resin, an epoxy resin-modified silicone resin, an alkyd resin, a modified silicone resin, or a rubber-based silicone resin can be used.

Among these, a methyl-based straight silicone resin, a methyl phenyl-based straight silicone resin, or an acrylic resin-modified silicone resin is more preferable, and a methyl-based straight silicone resin or a methyl phenyl-based straight silicone resin is still more preferable.

Among the resins having a siloxane bond in the main chain thereof, one kind may be used alone, or a mixture of two or more kinds may be used. By mixing the two or more kinds at an arbitrary ratio, film physical properties can be controlled.

The resin having a siloxane bond in the main chain thereof may be used after being dissolved in an organic solvent or the like and may be used after being dissolved in, for example, a xylene solution.

From the viewpoint of improving curability, it is preferable that a well-known compound as a polymerization catalyst is added to the resin having a siloxane bond in the main chain thereof, and it is more preferable that a zinc-based polymerization catalyst is added to the resin having a siloxane bond in the main chain thereof.

However, within a range not departing from the scope of the present invention, “layer containing the binder resin” in the transfer layer 2 may contain “another binder resin”.

Examples of the other binder resin include a copolymer of (meth)acrylic acid/benzyl methacrylate, a copolymer of (meth)acrylic acid/benzyl methacrylate/methyl(meth)acrylate, a copolymer of (meth)acrylic acid/benzyl methacrylate/methyl(meth)acrylate/ethyl(meth)acrylate, a copolymer of (meth)acrylic acid/benzyl methacrylate/methyl(meth)acrylate/butyl(meth)acrylate, a copolymer of (meth)acrylic acid/benzyl methacrylate/methyl(meth)acrylate/cyclohexyl(meth)acrylate, a copolymer of (meth)acrylic acid/benzyl methacrylate/methyl(meth)acrylate/isobornyl(meth)acrylate, and a copolymer of (meth)acrylic acid/benzyl methacrylate/methyl(meth)acrylate/styrene.

Among these, from the viewpoint of avoiding the incorporation of bubbles during thermal pressure bonding, a copolymer of (meth)acrylic acid/benzyl methacrylate, a copolymer of (meth)acrylic acid/benzyl methacrylate/methyl(meth)acrylate, or a copolymer of (meth)acrylic acid/benzyl methacrylate/methyl(meth)acrylate/ethyl(meth)acrylate is preferable.

In addition, the glass transition temperature Tg (b) of the other binder resin is preferably within a range of 70° C. to 140° C. and more preferably within a range of 80° C. to 110° C. When Tg (b) is 70° C. or higher, the incorporation of air (bubbles) during thermal pressure bonding can be suppressed. When Tg (b) is 140° C. or lower, the incorporation of air (bubbles) during thermal pressure bonding is sufficient, and development can be favorably performed.

The weight average molecular weight Mw (b) of the other binder resin is preferably within a range of 10,000 to 50,000 and more preferably within a range of 15,000 to 40,000. When Mw (b) is 10,000 or higher, the incorporation of air (bubbles) during thermal pressure bonding (lamination) can be suppressed. When Mw (b) is 50,000 or lower, the incorporation of air (bubbles) during thermal pressure bonding is sufficient, and development can be favorably performed.

The content of the other binder resin in the “layer containing the binder resin” of the transfer layer 2 is preferably 30 mass % or higher with respect to the total solid content of the “layer containing the binder resin”. When the content of the other binder resin is within the above-described range, the melt viscosity of the light shielding layer during thermal pressure bonding can be maintained to the extent that the light shielding layer is not excessively flexible, a certain degree of hardness can be maintained, and the incorporation of bubbles during thermal pressure bonding can be efficiently suppressed.

The content of the other binder resin is more preferably 10 mass % to 40 mass % and still more preferably 20 mass % to 35 mass %.

Antioxidant:

The antioxidant may be added to the transfer layer 2. It is more preferable that the antioxidant is added to the white layer 2a of the transfer layer 2. As the antioxidant, a hindered phenol antioxidant, a semi-hindered phenol antioxidant, a phosphoric acid antioxidant, or a hybrid antioxidant having phosphoric acid and hindered phenol in the molecules can be used.

Examples of the hindered phenol compound include ADEKA STAB AO-60 (manufactured by ADEKA Corporation).

From the viewpoint of suppressing discoloration, as the antioxidant, a phosphoric acid antioxidant such as IRGAFOS 168 (manufactured by BASF SE) is preferable.

Solvent:

As a solvent for forming the transfer layer 2 by coating, a solvent described in paragraphs [0043] and [0044] of JP2011-95716A can be used.

Additives:

In the transfer layer 2, other additives may be used. Examples of the additives include a surfactant described in paragraph [0017] of JP4502784B and in paragraphs [0060] to [0071] of JP2009-237362A, a thermal polymerization inhibitor described in paragraph [0018] of JP4502784B, and other additives described in paragraphs [0058] to [0071] of JP2000-310706A.

—Layer of Transfer Layer Adjacent to Protective Film, White Layer—

Components contained in the white layer 2a other than the pigment are not particularly limited, and examples thereof include well-known binder resins, resins having a siloxane bond in the main chain thereof, well-known pigment dispersion stabilizers, and well-known coating auxiliary agents. Among these, it is preferable that the color of the white layer 2a is not changed or is changed to a desired color.

From the viewpoint of obtaining the effects of the present invention, in the white layer 2a, a ratio of the mass of the “resin having a siloxane bond in the main chain thereof” to the mass of the “components other than the pigment” is preferably 80 mass % or higher and more preferably 90 mass % or higher.

In the white layer 2a, the content of components “other than the resin having a siloxane bond in the main chain thereof and the pigment” is preferably 30 mass % or higher with respect to the total solid content of the white layer 2a. When the “content of components other than the resin having a siloxane bond in the main chain thereof and the pigment” is within the above-described range, there may be an advantageous effect on the color of the white layer 2a.

In the white layer 2a, the content of components “other than the resin having a siloxane bond in the main chain thereof and the pigment” is more preferably 30 mass % to 60 mass %, still more preferably 35 mass % to 55 mass %, and even still more preferably 40 mass % to 50 mass %.

—Layer of Transfer Layer Adjacent to Release Layer, Light Shielding Layer—

The components which can be used in the light shielding layer 2b “other than the resin having a siloxane bond in the main chain thereof and the pigment” are the same as those which can be used in the white layer 2a.

From the viewpoint of obtaining the effects of the present invention, in the light shielding layer 2b, a ratio of the mass of the “resin having a siloxane bond in the main chain thereof” to the mass of the “components other than the pigment” is preferably 60 mass % or higher and more preferably 70 mass % or higher.

In the substrate with a transfer layer, in the white layer 2a, a ratio of the mass of the “resin having a siloxane bond in the main chain thereof” to the mass of the “components other than the pigment” is 90 mass % or higher; and in the light shielding layer 2b, a ratio of the mass of the “resin having a siloxane bond in the main chain thereof” to the mass of the “components other than the pigment” is preferably 70 mass % or higher. In this case, a more preferable range in the substrate with a transfer layer is the same as the above-described more preferable range or still more preferable range in the white layer 2a or the light shielding layer 2b.

(Characteristics of Colorant Layer)

### —Layer of Transfer Layer Adjacent to Protective Film, White Layer—

The thickness of the layer of the transfer layer 2 adjacent to the protective film 13 is preferably 10 μm to 40 μm from the viewpoint of improving the hiding power of the white layer 2a.

The thickness of the white layer 2a is more preferably 15 μm to 40 μm and still more preferably 20 μm to 38 μm.

From the viewpoint of improving the hiding power of the white layer 2a, the optical density (also referred to as “OD”) of the white layer 2a is preferably 0.5 or higher and more preferably 1.0 or higher.

—Layer of Transfer Layer Adjacent to Release Layer, Light Shielding Layer—

In the transfer material 20, it is preferable that the transfer layer 2 includes at least two layers and that the optical density of the layer of the transfer layer 2 adjacent to the release layer 12 is higher than that of the layer of the transfer layer adjacent to the protective film 13. In the transfer material 20, it is more preferable that the optical densities of the layers of the transfer layer 2 increase toward the release layer 12.

From the viewpoint of improving the hiding power of the light shielding layer, in the transfer material 20, the transfer layer 2 includes at least two layers, and the optical density of the layer of the transfer layer 2 adjacent to the release layer 12 is preferably 1.0 to 6.0, more preferably 3.5 to 6.0, and still more preferably 4.0 to 6.0.

In the transfer material 20, the transfer layer 2 includes at least two layers, and the thickness of the layer of the transfer layer 2 adjacent to the release layer 12 is preferably 0.5 μm to 3.0 μm, more preferably 1.0 μm to 3.0 μm, and still more preferably 1.5 μm to 3.0 μm.

It is preferable that the transfer material 20 in the substrate with a transfer layer which is used in a method for manufacturing the touch panel 10 has a sufficient surface resistance because wiring and a transparent conductive layer are formed in a region ranging from the vicinity of the transfer material 20 to the substrate. Specifically, the surface resistance of the transfer layer 2 in the substrate with a transfer layer which is obtained using the transfer material 20 is preferably 1.0×10¹⁰Ω/□ or higher, more preferably 1.0×10¹¹Ω/□ or higher, still more preferably 1.0×10¹²Ω/□ or higher, and even still more preferably 1.0×10¹³Ω/□ or higher.

<Protective Film>

In order to protect the transfer material 20 from being contaminated or damaged during storage, it is preferable that the protective film 13 (also referred to as “cover film”) is provided on the transfer material 20 so as to cover the colorant layer 2a. The protective film 13 may be formed of the same or similar material as that of the temporary support 11, but it is necessary that the protective film 13 is relatively easily peeled off from the colorant layer 2a. As the material of the protective film 13, for example, silicone paper, a polyolefin film, or a polytetrafluoroethylene sheet is appropriate.

From the viewpoint of effectively suppressing voids after the development of the colorant layer 2a, the maximum haze value of the protective film 13 is preferably 3.0% or lower, more preferably 2.5% or lower, still more preferably 2.0% or lower, and even still more preferably 1.0% or lower.

The thickness of the protective film 13 is preferably 1 μm to 100 μm, more preferably 5 μm to 50 μm, and still more preferably 10 μm to 30 μm. When the thickness is 1 μm or more, the strength of the protective film 13 is sufficient. Therefore, when the protective film 13 is bonded to a photosensitive resin layer, the protective film 13 is not likely to be fractured. When the thickness is 100 μm or less, the protective film 13 is not expensive, and the protective film 13 is not likely to be wavy during lamination.

Examples of a commercially available product of the protective film 13 include: polypropylene films such as ALPHAN MA-410, E-200C, and E-501 manufactured by Oji F-Tex Co., Ltd. and products manufactured by Shin-Etsu Film Co., Ltd; and polyethylene terephthalate films such as PS series of PS-25 and the like manufactured by Teijin Ltd. The protective film 13 is not limited to the above examples. In addition, the protective film 13 may be manufactured by sandblasting a commercially available film.

As the protective film 13, a polyolefin film such as a polyethylene film can be preferably used. Typically, the polyolefin film used as the protective film 13 can be manufactured by causing molten raw materials to undergo kneading, extruding, biaxial stretching, casting, or an inflation method.

It is preferable that the protective film 13 is a polypropylene film.

Hereinabove, the transfer material 20 has been described. However, the transfer material 20 may be a negative type material or a positive type material as appropriate.

[Method for Manufacturing Transfer Material]

A method for manufacturing the transfer material 20 includes the following steps (1) to (3):
(1) preparing the temporary support 11 including the release layer 12;
(2) forming the transfer layer 2 on the release layer 12 side of the temporary support 11; and
(3) bonding the protective film 13 to the transfer layer 2 side.

The method for manufacturing the transfer material 20 is not particularly limited as long as it includes the above steps (1) to (3) and, for example, may include steps described in paragraphs [0064] to [0066] of JP2005-3861A. In addition, the transfer material 20 can also be manufactured using a method described in, for example, JP2009-116078A.

(1) Step of Preparing Temporary Support Including Release Layer 12

The method for manufacturing the transfer material 20 includes (1) the step of preparing the temporary support 11 including the release layer 12.

A method for preparing the temporary support 11 including the release layer 12 is not particularly limited, and a well-known commercially available product may be used as the temporary support 11 including the release layer 12.

(2) Step of Forming Transfer Layer 2 on Release Layer 12 Side of Temporary Support 11

The method for manufacturing the transfer material 20 includes (2) the step of forming the transfer layer 2 on the release layer 12 side of the temporary support 11.

Examples of the step of forming the transfer layer 2 on the release layer 12 side of the temporary support 11 include a step of applying a resin composition to the temporary support 11 including the release layer 12 and drying the resin composition to form the transfer layer 2 on the temporary support 11.

In the transfer material 20, at least two layers including the white layer 2a and the light shielding layer 2b may be formed as the transfer layer 2. In this case, in the transfer material 20, a laminate in which the release layer 12, the white layer 2a, and the light shielding layer 2b are laminated on the temporary support 11 may be used. According to this configuration, by transferring the transfer material 20 to the transfer target substrate, the white layer 2a as a white decorative material and the light shielding layer 2b as a light shielding material can be provided on the transfer target substrate, which is preferable during the manufacturing process.

Alternatively, at least one layer of the white layer 2a and the light shielding layer 2b may be formed as the transfer layer 2. In this case, the temporary support 11 is removed after the transfer material 20 including the temporary support 11, the release layer 12, and the white layer 2a is transferred to the transfer target substrate. As a result, the transfer material 20 including the temporary support 11 and the light shielding layer 2b is transferred to the white layer 2a.

The transfer material 20 may further include other layers within a range not departing from the scope of the present invention.

As a method for applying the composition for forming the transfer layer 2 to the temporary support 11, a well-known coating method can be used. For example, the transfer layer 2 can be formed by applying a coating liquid of the composition to the temporary support 11 using a coating machine such as a spinner, a whirler, a roll coater, a curtain coater, a knife coater, a wire bar coater, or an extruder and drying the coating liquid.

—Solvent—

The photosensitive composition for forming the transfer layer 2 of the transfer material 20 can be suitably prepared using respective components contained in the photosensitive composition and a solvent.

Examples of the solvent are as follows:
esters, for example, ethyl acetate, n-butyl acetate, isobutyl acetate, amyl formate, isoamyl acetate, butyl propionate, isopropyl butyrate, ethyl butyrate, butyl butyrate, alkyl esters, methyl lactate, ethyl lactate, methyl oxyacetate, ethyl oxyacetate, butyl oxyacetate, methyl methoxyacetate, ethyl methoxyacetate, butyl methoxyacetate, methyl ethoxyacetate, ethyl ethoxyacetate, 3-oxypropionic acid alkyl esters (for example, 3-methyl methoxypropionate, 3-ethyl methoxypropionate, 3-methyl ethoxypropionate, and 3-ethyl ethoxypropionate) such as 3-methyl oxypropionate and 3-ethyl oxypropionate, 2-oxypropionic acid alkyl esters (for example, 2-methyl methoxypropionate, 2-ethyl methoxypropionate, 2-propyl methoxypropionate, 2-methyl ethoxypropionate, 2-ethyl ethoxypropionate, 2-oxy-2-methyl methylpropionate, 2-oxy-2-ethyl methylpropionate, 2-methoxy-2-methyl methylpropionate, 2-ethoxy-2-ethyl methylpropionate) such as 2-methyl oxypropionate, 2-ethyl oxypropionate, and 2-propyl oxypropionate, methyl pyruvate, ethyl pyruvate, propyl pyruvate, methyl acetoacetate, ethyl acetoacetate, 2-methyl oxobutanoate, and 2-ethyl oxobutanoate;
ethers, for example, diethylene glycol dimethyl ether, tetrahydrofuran, ethylene glycol monomethyl ether, ethylene glycol monoethyl ether, methyl cellosolve acetate, ethyl cello solve acetate, diethylene glycol monomethyl ether, diethylene glycol monoethyl ether, diethylene glycol monobutyl ether, propylene glycol monomethyl ether acetate, propylene glycol monoethyl ether acetate, and propylene glycol propyl ether acetate;
ketones, for example, methyl ethyl ketone, methyl isobutyl ketone, cyclohexanone, 2-heptanone, and 3-heptanone; and
aromatic hydrocarbons, for example, toluene and xylene.

Among these, for example, methyl ethyl ketone, methyl isobutyl ketone, xylene, cyclohexanone, propylene glycol monomethyl ether, or propylene glycol monomethyl ether acetate is preferable.

Among these solvents, one kind may be used alone, or a combination of two or more kinds may be used.

(3) Step of Bonding Protective Film 13 to Transfer Layer 2 Side

The method for manufacturing the transfer material 20 includes (3) the step of bonding the protective film 13 to the transfer layer 2 side.

A method for covering the transfer layer 2 with the protective film 13 is not particularly limited. For example, a method for disposing the protective film 13 to overlap the transfer layer 2 on the temporary support 11 and pressure-bonding the protective film 13 and the transfer layer 2 to each other can be used.

For the pressure-bonding, a well-known laminator such as a Roll laminator a vacuum laminator, or an Auto-Cut laminator capable of improving productivity can be used.

Preferable pressure-bonding conditions are atmosphere temperature: 40° C. to 130° C. and linear pressure: 1000 N/m to 10000 N/m. When at least one of the atmosphere temperature and the linear pressure is lower than the above-described range, air incorporated during lamination may be insufficiently pushed out from a gap between the transfer target substrate and the transfer layer 2. In addition, when the atmosphere temperature is higher than the above-described range, the transfer layer 2 may enter into an unfavorable state due to thermal curing. When the linear pressure is higher than the above-described range, the transfer layer 2 may be deformed.

[Substrate with Transfer Layer and Method for Manufacturing Substrate with Transfer Layer]

The method for manufacturing a substrate with a transfer layer using the transfer material 20 includes the following steps:

(11) peeling off the protective film 13 from the transfer material 20;

(12) transferring the transfer layer 2 side of the transfer material 20 to the glass substrate 101a or the film substrate 101b; and

(13) simultaneously peeling off the release layer 12 and the temporary support 11 from the transfer layer 2.

Hereinafter, a preferable embodiment of the substrate with a transfer layer and the manufacturing method therefor will be described.

<Characteristics of Substrate with Transfer Layer>

“Decorative material” in the substrate with a transfer layer refers to the laminate including the white layer 2a and the light shielding layer 2b. When only the white layer 2a is transferred to the transfer target substrate, the optical density is low. Therefore, when the substrate with a transfer layer having the above-described configuration is used as a substrate for a display device, light may leak from the display device, or a circuit may be seen through the substrate. In the substrate with a transfer layer, the light leakage and the like can be suppressed by adopting a configuration in which the white layer 2a and the light shielding layer 2b are formed in this order from the substrate (film or glass).

The optical density of the substrate with a transfer layer is preferably 3.5 to 6.5, more preferably 4.0 to 6.0, and still more preferably 4.5 to 5.5. The optical density may be obtained as a total value for each layer. When the optical density exceeds the upper limit capable of being measured by an optical density meter, the sum of the optical density of the light shielding layer 2b and the optical density of the white layer 2a is obtained as the optical density of the substrate with a transfer layer. For example, it is assumed that the upper limit which can be measured by the optical density meter is 6.0. In this case, when the optical density of only the light shielding layer is measured as 5.5 and the optical density of only the white layer is measured as 1.0, the optical density of the substrate with a transfer layer is 6.5 which is the sum of both of the optical densities.

<Transfer Target Substrate>

The substrate with a transfer layer used in the transfer target substrate is formed of glass or a film selected from TAC, PET, PC and, COP. It is preferable that the transfer target substrate is the film substrate 101b, and it is more preferable that the transfer target substrate has no optical distortion and high transparency. In the substrate with a transfer layer, the total light transmittance of the transfer target substrate is preferably 80% or higher.

Specific examples of the material of the film substrate 101b include polyethylene terephthalate (PET), polyethylene naphthalate, polycarbonate (PC), triacetyl cellulose (TAC), a cycloolefin polymer (COP).

The transfer target substrate may be the glass substrate 101a.

In the substrate with a transfer layer, it is preferable that the transfer target substrate is formed of glass or a film of COP.

Various functions may be imparted to the surface of the transfer target substrate. Specific examples of the functions include an anti-reflection layer, an anti-glare layer, a phase difference layer, a visual angle enhancing layer, an anti-scratch layer, a self-repairing layer, an antistatic layer, an antifouling layer, an anti-electromagnetic layer, and a conductive layer.

In the substrate with a transfer layer, it is preferable that a conductive layer is formed on the surface of the transfer target substrate. As the conductive layer, a conductive layer described in JP2009-505358A can be used.

It is more preferable that the transfer target substrate further contains at least one of an anti-scratch layer and an anti-glare layer.

In the substrate with a transfer layer, the thickness of the transfer target substrate is preferably 40 μm to 200 μm, more preferably 40 μm to 150 μm, and still more preferably 50 μm to 120 μm.

In addition, in order to improve the adhesion of the transfer layer 2 during lamination of a transfer step, a non-contact surface of the transfer target substrate (front surface plate) can be treated in advance. It is preferable that the surface is treated with a silane compound (silane coupling agent). It is preferable that the silane coupling agent has a functional group which interacts with a photosensitive resin. For example, the surface is sprayed with a silane coupling solution (an aqueous solution containing 0.3 mass % of N-(β-aminoethyl)-γ-aminopropyl-trimethoxysilane, product name: KBM 603, manufactured by Shin-Etsu Chemical Co., Ltd.) by showering for 20 seconds and is cleaned by pure water showering. Next, the surface is heated to cause a reaction. In this case, a heating bath may be used, or the reaction may be promoted by pre-heating the transfer target substrate using a laminator.

—Step of Forming Transfer Material into Desired Shape—

The method for manufacturing a substrate with a transfer layer may include (11) a step of forming the transfer material 20 into a desired shape before the step of peeling off the protective film 13 from the transfer material 20. A method for forming the transfer material 20 into a desired shape is not particularly limited. For example, it is preferable that a notch having a depth in a thickness direction so as to penetrate at least the transfer layer 2 and having a linear portion in an in-plane direction is formed on the transfer material 20 including the temporary support 11, the release layer 12, and the transfer layer 2. The depth of the notch is not particularly limited.

It is preferable that the notch is formed on the transfer material 20 so as to have four or more linear portions in the in-plane direction (in this specification, “linear portion” refers to a straight line portion and has the same meaning as that of a line segment). The notch formed on the transfer material 20 may also have a “large radius arc shape” or a “sine-wave shape”. However, in the manufacturing method according to the present invention, it is particularly useful to form a notch having a linear portion.

In the manufacturing method according to the present invention, a method of forming the notch on the transfer material 20 is not particularly limited. It is preferable that the notch is formed using a method selected from Thomson blade cutting or laser light processing.

In regard to the notch formed on the transfer material 20, two configurations may be adopted: (A-1) the notch formed on the transfer material 20 may have a depth in the thickness direction so as to penetrate all the layers of the transfer material 20; and alternatively, (A-2) the notch may have a depth so as to penetrate the transfer layer 2 and not penetrate the temporary support 11.

The method (A-1) in which the notch formed on the transfer material 20 has a depth in the thickness direction so as to penetrate all the layers of the transfer material 20 is called “punching”. When punching is performed in Step (A), it is preferable to simultaneously perform Step (B) of removing the transfer layer 2 in a region ranging from a partial region of the transfer material 20 in the in-plane direction to the depth of the notch. A configuration of simultaneously performing punching and the removal of the transfer layer is also called “hollowing”.

On the other hand, the method (A-2) in which the notch has a depth so as to penetrate the transfer layer 2 and not penetrate the temporary support 11 is called “half cutting”

In particular, the method (A-1) in which the notch formed on the transfer material 20 has a depth in the thickness direction so as to penetrate all the layers of the transfer material 20 is preferable.

(Punching Method)

For the punching of the transfer material 20, well-known means can be used.

Examples of a mechanical punching method include flat punching using a Thomson blade and cylindrical punching using a die cutting roller.

Examples of an optical punching method include a method using a CO₂ laser cutter.

In addition, the punching method may be a sheet type or a continuous type (roll-to-roll type).

Examples of a device used for the mechanical punching method include L-CPNC 550 (manufactured by Climb Products Co., Ltd.).

(Half-Cutting Method)

The half-cutting method is not particularly limited as a method for forming the notch. For example, the notch can be formed with an arbitrary method using a blade, a laser, or the like. In the half-cutting method, it is preferable to form the notch using a blade. In addition, the structure of the blade is not particularly limited.

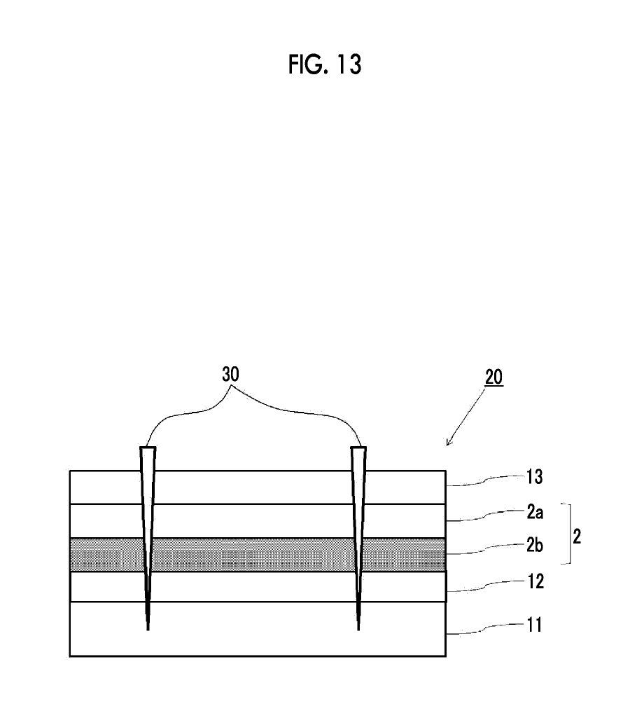

For example, as shown in FIG. 13, using a blade 30 or laser, a notch is formed in a region ranging from the protective film 13 to a part of the temporary support 11 so as to penetrate the protective film 13, the transfer layer 2, and the release layer 12. As a result, a transfer portion (image portion) of the transfer layer 2 and a non-transfer portion (non-image portion) of the transfer layer 2 can be separated from each other.

—(11) Step of Peeling Off Protective Film 13 from Transfer Material 20—

The method for manufacturing a substrate with a transfer layer includes the step of peeling off the protective film 13 from the transfer material 20.

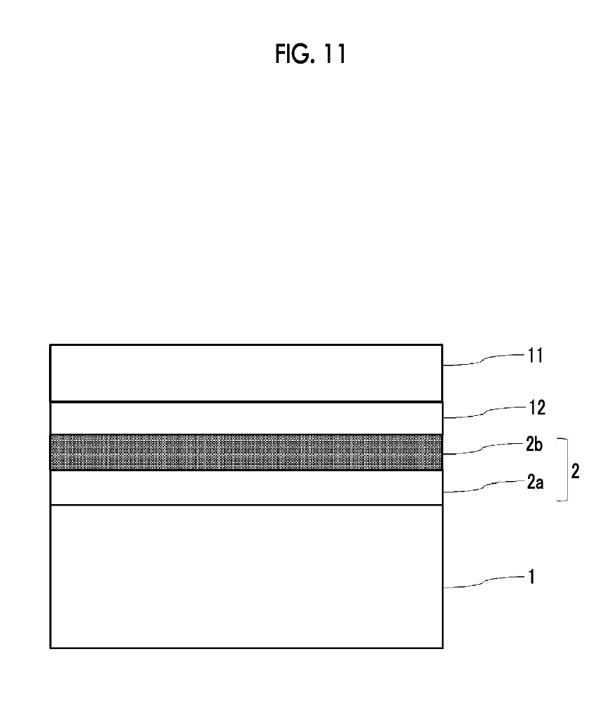

FIG. 11 shows a method for peeling off the protective film 13 from the transfer material 20. A specific method for peeling off the protective film 13 is not particularly limited. When the protective film 13 is peeled off from the transfer material 20 in the step of peeling off the protective film 13 from the transfer material 20, the protective film 13 is peeled from the transfer layer 2 and the transfer layer 2 remains on the release layer 12 side.

—(12) Step of Transferring Transfer Layer 2 Side of Transfer Material 20 to Front Surface Plate 1—

The method for manufacturing a substrate with a transfer layer includes the step of transferring the transfer layer 2 side of the transfer material 20 to the transfer target substrate (the glass substrate 101a or the film substrate 101b). “Transfer layer 2 side of the transfer material 20” refers to the side of the transfer layer 2 exposed to the surface of the transfer material 20 after the protective film 13 is peeled off from the transfer material 20.

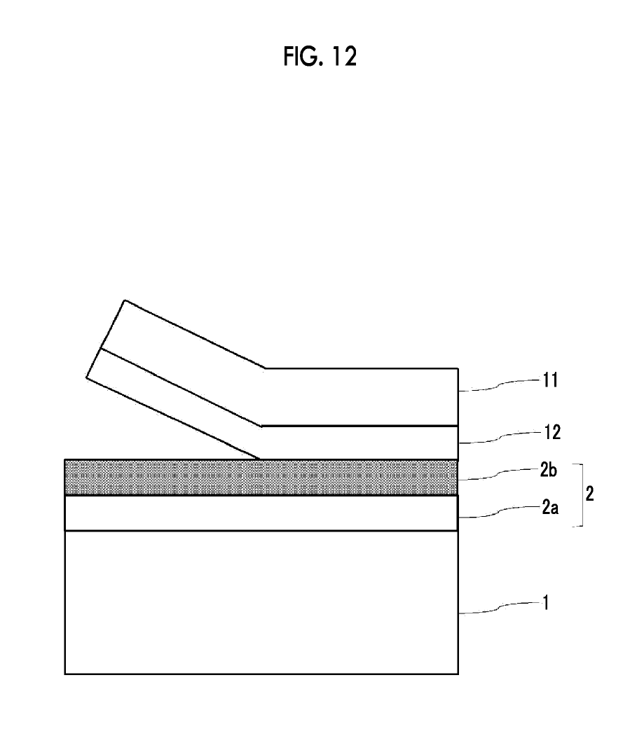

FIG. 12 shows a method for transferring the transfer layer 2 (white layer 2a) side from the transfer material 20 to the front surface plate 1.

In the method for manufacturing a substrate with a transfer layer, it is preferable that the transfer material 20 including at least the temporary support 11, the release layer 12, the light shielding layer 2b, and the white layer 2a is transferred to the front surface plate 1.

In the method for manufacturing a substrate with a transfer layer, two of the transfer materials 20 may be transferred to the front surface plate 1. For example, the transfer material 20 including the temporary support 11, the release layer 12, and the light shielding layer 2b and the transfer material 20 including the temporary support 11, the release layer 12, and the white layer 2a may be transferred to the front surface plate 1 so as to form the white layer 2a and the light shielding layer 2b.

Alternatively, after the transfer material 20 including the temporary support 11, the release layer 12, and the white layer 2a is transferred to the front surface plate 1, the temporary support 11 may be removed, and then the transfer material 20 including the temporary support 11, the release layer 12, and the light shielding layer 2b may be transferred to the white layer 2a so as to form the white layer 2a and the light shielding layer 2b.

From the viewpoint of maintaining the configuration of the transfer layer 2, when the transfer layer 2 is transferred to the front surface plate 1, the temperature of the front surface plate 1 is preferably 40° C. to 130° C., more preferably 40° C. to 110° C., and still more preferably 40° C. to 100° C.

It is preferable that the transfer layer 2 is transferred (bonded) to the surface of the front surface plate 1 by disposing the transfer layer 2 to overlap the surface of the front surface plate 1 and applying heat and pressure thereto. For the bonding, a well-known laminator such as a Roll laminator, a vacuum laminator or an Auto-Cut laminator capable of improving productivity can be used.

In the laminating method, the punched transfer material 20 is transferred to the front surface plate 1. Therefore, it is preferable that the laminating method is a sheet type from the viewpoint of preventing bubbles from being incorporated in to a gap between the front surface plate 1 and the transfer material 20 to improve the yield.

As a method for transferring the transfer layer 2 to the surface of the front surface plate 1, a method using a vacuum laminator is preferable.

Examples of a device used for the lamination (continuous type or sheet type) include V-SE340aaH (manufactured by Climb Products Co., Ltd.).

Examples of the vacuum laminator include a device manufactured by Takanoseiki Co., Ltd. and FVJ-540R and FV700 (manufactured by Taisei Laminator Co., Ltd.).

From the viewpoint of preventing the incorporation of bubbles during lamination, it is preferable that the method for manufacturing a substrate with a transfer layer further includes a step of laminating a support on a side of the temporary support 11 opposite the transfer layer 2 before the transfer material 20 is bonded to the front surface plate 1. The support used at this time is not particularly limited, and examples thereof are as follows:
polyethylene terephthalate, polycarbonate, triacetyl cellulose, and a cycloolefin polymer.

In addition, the thickness of the support can be selected in a range of 50 μm to 200 μm.

—(13) Step of Simultaneously Peeling Off Release Layer 12 and Temporary Support 11 from Transfer Layer 2—

The method for manufacturing a substrate with a transfer layer includes the step of simultaneously peeling off the release layer 12 and the temporary support 11 from the transfer layer 2. By peeling off the temporary support 11, the release layer 12 is peeled off from the transfer layer 2 together with the temporary support 11.

FIG. 12 shows the step of simultaneously peeling off the release layer 12 and the temporary support 11 from the light shielding layer 2b of the transfer layer 2.

After the lamination, the peeling strength of the release film from the transfer material 20 (the peeling strength of the release layer 12 from the transfer layer 2) is preferably 400 mN/m or lower. When the peeling strength is 400 mN/m or lower, during the peeling of the release film, the release film does not have an unnecessary effect on the transfer layer 2 by attaching an adhesive tape to the release film and removing the adhesive tape together with the release film.

When the peeling strength is higher than 400 mN/m, during the peeling of the release film, for example, it is necessary that a thin blade or jig is inserted between the transfer layer 2 and the release film to remove the release film. At this time, the transfer layer 2 may be damaged. In addition, for example, a stain may stick to the transfer layer 2, which has an adverse effect on the quality of the transfer layer 2.

—Post Baking Step—

It is preferable that the method for manufacturing the transfer material 20 includes a post baking step after the transfer step.

In the method for manufacturing the transfer material 20, from the viewpoint of simultaneously improving whiteness and productivity, it is preferable that the white layer 2a and the light shielding layer 2b of the transfer material 20 are formed by heating at 180° C. to 300° C. in an environment of 0.08 atm to 1.2 atm.

The heating of post baking is performed preferably in an environment of 0.5 atm or higher, more preferably in an environment of 1.1 atm or lower, and still more preferably in an environment of 1.0 atm or lower. From the viewpoint of reducing the manufacturing cost without using a special pressure reducing device, the heating of post baking is performed even still more preferably in an environment of about 1 atm (atmospheric pressure). In the related art, the white layer 2a and the light shielding layer 2b are formed by thermal curing in a pressure reduced environment of an extremely low pressure to reduce the oxygen concentration. Therefore, the whiteness after baking can be maintained. On the other hand, by using the transfer material 20, the colors of the white layer 2a and the light shielding layer 2b of the substrate with a transfer layer can be improved (b value can be reduced), and the whiteness can be improved even after the baking in the above-described pressure range.

The post baking temperature is more preferably 200° C. to 280° C. and still more preferably 220° C. to 260° C.

The post baking time is more preferably 20 minutes to 150 minutes and still more preferably 30 minutes to 100 minutes.

Post baking may be performed in an air environment or a nitrogen substitution environment. From the viewpoint of reducing the manufacturing cost without using a special pressure reducing device, it is more preferable that post baking is performed in an air environment.

—Other Steps—

The method for manufacturing the transfer material 20 may include other steps such as a post exposure step.

When the transfer layer 2 contains a photocurable resin, it is preferable that the method for manufacturing the transfer material 2 include a post exposure step during the formation of the white layer 2a and the light shielding layer 2b. The post exposure step may be performed only in a direction of a surface of the white layer 2a and the light shielding layer 2b which is in contact with the substrate, only in a direction of a surface thereof which is not in contact with the front surface plate 1, or in both of the directions.

As examples of an exposure step and other steps, methods described in paragraphs [0035] to [0051] of JP2006-23696A can be preferably used in the present invention.

[Touch Panel and Method for Manufacturing Touch Panel]

The touch panel 10 includes the substrate with a transfer layer.

It is preferable that the touch panel 10 is a capacitive input device.

The method for manufacturing the touch panel 10 using the substrate with a transfer layer include the following steps:
(21) forming a conductive layer on the transfer layer 2 side of the substrate with a transfer layer; and
(22) removing a part of the conductive layer to form an electrode pattern.
(21) Step of Forming Conductive Layer on Transfer Layer 2 Side of Substrate with Transfer Layer

It is preferable that the substrate with a transfer layer further includes a conductive layer on the light shielding layer 2b.

As the conductive layer, a conductive layer described in JP2009-505358A can be used.
(22) Step of Removing Part of Conductive Layer to Form Electrode Pattern

The configuration of the conductive layer, the step of removing a part of the conductive layer to form an electrode pattern, and the shape of the electrode pattern formed by removing a part of the conductive layer will be described below in the description of a first transparent electrode pattern 3, a second electrode pattern 4, and a third conductive layer 6.

In the substrate with a transfer layer, it is preferable that the conductive layer contains indium (including an indium-containing compound such as ITO or an indium alloy).

In a case where the b value of the white layer 2a in the substrate with a transfer layer after a high-temperature treatment is low, even when the conductive layer is vapor-deposited by sputtering, the b value of the white layer 2a of the obtained substrate with a decorative material can be reduced.

<Touch Panel 10, and Information Input Device Including Touch Panel 10 as Component>

It is preferable that the touch panel 10 includes a substrate with a transfer layer including: a front surface plate that is the front surface plate 1; and at least the following components (31) to (34) that are formed on a non-contact side (upper side in FIGS. 1A and 1B) of the front surface plate:
(31) a decorative material that includes the light shielding layer 2b and the white layer 2a;
(32) plural first conductive layers (first transparent electrode pattern 3) in which plural pads are formed to extend in a first direction through connection portions;
(33) plural second conductive layers (second electrode pattern 4) that are electrically insulated from the first transparent electrode pattern 3 and in which plural pads are formed to extend in a direction intersecting the first direction; and
(34) an insulating layer 5 that electrically insulates the first transparent electrode pattern 3 and the second electrode pattern 4 from each other.

The second electrode pattern 4 may be a transparent electrode pattern.

The touch panel 10 may further include the following component (35):
(35) a third conductive layer 6 (hereinafter, also referred to simply as “conductive element 6”) that is electrically connected to at least one of the first transparent electrode pattern 3 or the second transparent electrode pattern 4 and is another conductive element different from the first transparent electrode pattern 3 and the second transparent electrode pattern 4.

It is more preferable that the touch panel 10 includes a substrate with a transfer layer that is a laminate including: the front surface plate; (31) the decorative material that includes the light shielding layer 2b and the white layer 2a; and at least one of the electrode patterns (32), (33), and (35) as a conductive layer.

<Configuration of Touch Panel 10>

First, the configuration of the touch panel 10 will be described. FIGS. 1A and 1B are cross-sectional view showing a preferable configuration of the touch panel 10. The touch panel 10 shown in FIG. 1A includes the glass substrate 101a, the white layer 2a, the light shielding layer 2b, the first transparent electrode pattern 3, the second transparent electrode pattern 4, the insulating layer 5, the conductive element 6, and a transparent protective layer 7.

It is preferable that the front surface plate is a translucent substrate. The translucent substrate can adopt any one of a configuration ((refers to FIG. 1A) in which the decorative material is provided on the glass substrate 101a and a configuration (refer to FIG. 1B) in which the decorative material is provided on the film substrate 101b of the laminate including the glass substrate 101a and the film substrate 101b in this order. The configuration in which the decorative material is provided on the glass substrate 101a is preferable from the viewpoint of reducing the size of the touch panel 10. The configuration in which the decorative material is provided on the film substrate 101b and then is bonded to the cover glass 101a is preferable from the viewpoint of improving the productivity of the touch panel 10.

The glass substrate 101a may be further provided on a side of the film substrate 101b opposite an electrode. As the glass substrate 101a, for example, tempered glass represented by Gorilla Glass (manufactured by Corning Inc.) can be used. In addition, a side (upper side in FIGS. 1A and 1B) of the front surface plate 1 where the respective components are provided will be referred to as “non-contact surface 1a”. In the touch panel 10, a desired instruction is input by touching a contact surface (surface opposite to the non-contact surface 1a; lower side in FIGS. 1A and 1B) of the front surface plate 1 with a finger or the like.

The white layer 2a and the light shielding layer 2b are provided on the non-contact surface 1a of the front surface plate 1 as the decorative material. The decorative material is a frame-shaped pattern surrounding a display region that is formed on the non-contact side of the front surface plate of the touch panel 10. The decorative material is formed for making a routing circuit or the like invisible or for decoration.

A wiring outlet (not shown) can be provided on the touch panel 10. When a decorative material is formed using a liquid resist or a screen printing ink for forming the decorative material, the back side of the front surface plate 1 may be contaminated due to the leakage of the resist component from the wiring outlet or the protrusion of the resist component from a glass end of the decorative material. On the other hand, when a decorative material is formed using the transfer material 20, the leakage or protrusion of the resist component is suppressed, and thus the contamination of the back side of the substrate is prevented.

On the non-contact surface 1a of the front surface plate 1, the plural first transparent electrode patterns 3, the plural second electrode patterns 4, and the insulating layer 5 are formed. In the first transparent electrode pattern 3, plural pads are formed to extend in the first direction through connection portions. The second transparent electrode pattern 4 is electrically insulated from the first transparent electrode pattern 3, in which plural pads are formed to extend in a direction intersecting the first direction. The insulating layer 5 electrically insulates the first transparent electrode pattern 3 and the second transparent electrode pattern 4 from each other.

The first transparent electrode pattern 3, the second electrode pattern 4, and the conductive element 6 can be prepared using a translucent conductive metal oxide film, for example, indium tin oxide (ITO) or indium zinc oxide (IZO). Examples of the metal film include an ITO film; a metal film of Al, Zn, Cu, Fe, Ni, Cr, or Mo; and a metal oxide film of SiO₂ or the like.

The thickness of each component may be 10 nm to 200 nm. The electrical resistance can be reduced by firing an amorphous ITO film to form a polycrystalline ITO film. In addition, the first transparent electrode pattern 3, the second transparent electrode pattern 4, and the conductive element 6 can also be manufactured using a transfer film including a photocurable resin layer in which a conductive fiber is used. In addition, when the first conductive pattern and the like are formed using ITO or the like, the details thereof can refer to paragraphs [0014] to [0016] of JP4506785B.

At least any one of the first transparent electrode pattern 3 and the second electrode pattern 4 can be provided on the non-contact surface 1a of the front surface plate 1, on a non-contact surface (upper side in FIGS. 1A and 1B) of the light shielding layer 2b, or on both of the regions.

In FIGS. 1A and 1B, the second electrode pattern 4 is provided on the non-contact surface 1a of the front surface plate 1, on the non-contact surface of the light shielding layer 2b, or on both of the regions, and the side surface of the white layer 2a is covered with the second transparent electrode pattern 4.

The width of the white layer 2a can be set to be narrower than that of the light shielding layer 2b. At least any one of the first transparent electrode pattern 3 and the second transparent electrode pattern 4 can be provided on the regions of the non-contact surface 1a of the front surface plate 1 and the non-contact surfaces of the white layer 2a and the light shielding layer 2b.

In this way, even when a transfer film is laminated on both the decorative material including the white layer 2a and the light shielding layer 2b, which is required to have a certain thickness, and the back surface of the front surface plate 1, by using the transfer material 20 (in particular, the transfer material having a thermoplastic resin layer described below), the formation of bubbles at a boundary of the decorative material is suppressed with a simple process without using expensive equipment such as a vacuum laminator.

—Thermoplastic Resin Layer—

The transfer film used for forming a conductive layer or the like may include at least one thermoplastic resin layer. It is preferable that the thermoplastic resin layer is provided between the temporary support and a photocurable resin layer. That is, it is preferable that the transfer film includes the temporary support, the thermoplastic resin layer, and the photocurable resin layer in this order.

As a component used for the thermoplastic resin layer, an organic polymer material described in JP1993-72724A (JP-H5-72724A) is preferable, and an organic polymer material having a softening point of about 80° C. or lower which is measured using a Vicat method (a method for measuring the softening point of a polymer according to America material testing method, ASTMD 1235) is more preferably selected.

Specific examples of the component used for the thermoplastic resin layer include organic polymers including: polyolefins such as polyethylene and polypropylene; ethylene copolymers of ethylene and vinyl acetate or a saponified product thereof, copolymers of ethylene and an acrylic acid ester or a saponified product thereof, polyvinyl chloride; vinyl chloride copolymers of vinyl chloride and vinyl acetate or a saponified product thereof, polyvinylidene chloride; vinylidene chloride copolymers; polystyrene; styrene copolymers of styrene and a (meth)acrylic acid ester or a saponified product thereof; polyvinyl toluene; vinyl toluene copolymers of vinyl toluene and a (meth)acrylic acid ester or a saponified product thereof, poly(meth)acrylic acid esters; (meth)acrylic acid ester copolymers of butyl(meth)acrylate and vinyl acetate or the like; vinyl acetate copolymer nylon; copolymer nylon; and polyamide resins such as N-alkoxymethylated nylon and N-dimethylaminated nylon.

The thickness of the thermoplastic resin layer is preferably 6 μm to 100 μm and more preferably 6 μm to 50 μm. In a case where the thickness of the thermoplastic resin layer is within a range of 6 μm to 100 μm, even when the surface of the substrate is rough, this roughness can be absorbed.

—Interlayer—

The transfer film used for forming the conductive layer or the like may include at least one interlayer in order to prevent components from being mixed with each other during the application of the plural coating layers, and during the storage after the application. It is preferable that the interlayer is provided between the temporary support and the colorant layer (when the thermoplastic resin layer is provided, between the thermoplastic resin layer and the photocurable resin layer). That is, it is preferable that the transfer material includes the temporary support, the thermoplastic resin layer, the interlayer, and the photocurable resin layer in this order.

As the interlayer, an oxygen barrier film having an oxygen barrier function which is described as “separation layer” in JP1993-72724A (JP-H5-72724A) is preferably used. In this case, the sensitivity during exposure is improved, the time load of an exposing device is reduced, and the productivity is improved.

It is preferable that the oxygen barrier film exhibits low oxygen permeability and can be dispersed or dissolved in water or an alkali aqueous solution. The oxygen barrier film can be appropriately selected from well-known ones. In particular, a combination of polyvinyl alcohol and polyvinyl pyrrolidone is preferable.

The thickness of the interlayer is preferably 0.1 μm to 5.0 μm and more preferably 0.5 μm to 2.0 μm. When the thickness of the interlayer is within a range of 0.1 μm to 5.0 μm, a long period of time is not required during development or during the removal of the interlayer without deterioration in the oxygen barrier function.

—Step of Removing Thermoplastic Resin Layer, Step of Removing Interlayer—

Further, when the transfer film used for forming the conductive layer or the like includes the thermoplastic resin layer and the interlayer, it is preferable that a step of removing the thermoplastic resin layer and the interlayer is provided.

The step of removing the thermoplastic resin layer and the interlayer can be performed using an alkali developer which is generally used in photolithography. The alkali developer is not particularly limited, and a well-known developer such as a developer disclosed in JP1993-72724A (JP-H5-72724A) can be used. It is preferable that the developer exhibits a development behavior of dissolving the decorative material. For example, a developer which contains a compound having a pKa value of 7 to 13 in a concentration of 0.05 mol/L to 5 mol/L is preferable. A small amount of an organic solvent having miscibility with water may be further added to the developer. Examples of the organic solvent having miscibility with water include methanol, ethanol, 2-propanol, 1-propanol, butanol, diacetone alcohol, ethylene glycol monomethyl ether, ethylene glycol monoethyl ether, ethylene glycol mono-n-butyl ether, benzyl alcohol, acetone, methyl ethyl ketone, cyclohexanone, ε-caprolactone, γ-butyrolactone, dimethyl formamide, dimethylacetamide, hexamethylphosphoramide, ethyl lactate, methyl lactate, ε-caprolactam, and N-methyl pyrrolidone. The concentration of the organic solvent is preferably 0.1 mass % to 30 mass %.

In addition, a well-known surfactant can be added to the alkali developer. The concentration of the surfactant is preferably 0.01 mass % to 10 mass %.

A method for performing the step of removing the thermoplastic resin layer and the interlayer may be, for example, paddling, showering, showering and spinning, and dipping. The developer can be sprayed by showering. As a result, the thermoplastic resin layer and the interlayer can be removed. In addition, it is preferable that, after the development, the substrate is sprayed with a cleaning agent or the like by showering to remove a residue thereof while being rubbed with a brush or the like. The liquid temperature is preferably 20° C. to 40° C., and pH is preferably 8 to 13.

In FIGS. 1A and 1B, the conductive element 6 is provided on the non-contact surface of the light shielding layer 2b. The conductive element 6 is electrically connected to at least any one of the first transparent electrode pattern 3 and the second electrode pattern 4 and is another conductive element different from the first transparent electrode pattern 3 and the second electrode pattern 4. In FIGS. 1A and 1B, the conductive element 6 is connected to the second electrode pattern 4.

In FIGS. 1A and 1B, the transparent protective layer 7 is provided so as to cover all of the respective components. The transparent protective layer 7 may be provided so as to cover a part of the respective components. The transparent protective layer 7 may be formed the same material as or a different material from that of the insulating layer 5. It is preferable that the material constituting the transparent protective layer 7 and the insulating layer 5 has high surface hardness and high heat resistance. For example, a well-known photosensitive siloxane resin material or an acrylic resin material is used.

The touch panel 10 and the information input device including the touch panel 10 as a component can adopt a configuration disclosed in, for example, “Advanced Touch Panel Technologies” (published by Techno Times Co., Ltd. on Jul. 6, 2009) edited by Yuji Mitani and “Technologies and Development of Touch Panels” by CMC Publishing Co., Ltd. (December 2004), FPD international 2009 Forum T-11 lecture textbook, Cypress Semiconductor Corporation Application Note AN2292.

[Information Display Device]

The information display device includes the touch panel 10.

As the information display device in which the touch panel 10 is used, a mobile device is preferable. For example, the following information display devices can be used:

IPhone 4 and IPad (both of which are manufactured by Apple Inc., USA); Xperia (SO-01B) (manufactured by Sony Mobile Communications Inc.); Galaxy S (SC-02B) and Galaxy Tab (SC-01C) (both of which are manufactured by Samsung Electronics Co., Korea); BlackBerry 8707h (Research In Motion Ltd., Canada); Kindle (manufactured by Amazon Co., Ltd. USA); and Kobo Touch (manufactured by Rakuten, Inc.).

### EXAMPLES

Hereinafter, the present invention will be described in detail using Examples. Materials, chemicals, proportions, instruments, operations, and the like shown in the following Examples can be appropriately changed within a range not departing from the scope of the present invention. The present invention is not limited to the following Examples. In the following Examples, unless specified otherwise, “%” and “part(s)” represent “mass %” and “part(s) by mass”, and the molecular weight represents the weight average molecular weight.

### Examples 1 to 8 and Comparative Example 2

### Preparation of Black Colorant Solution and White Colorant Solution

Black colorant solutions 1 and 2 and white colorant solutions 1 to 3 were prepared. The compositions of the black colorant solutions 1 and 2 and the white colorant solutions 1 to 3 are shown in Table 1 below.

TABLE 1

| | | | White | White | White |
|---|---|---|---|---|---|
| | Black Colorant | Black Colorant | Colorant | Colorant | Colorant |
| | Solution 1 | Solution 2 | Solution 1 | Solution 2 | Solution 3 |
| Black Dispersion 1 | 252 | 194 | | | |
| White Dispersion | | | 167 | 145 | 314 |
| Silicone Resin Solution 1 | 89.7 | | | | |
| Silicone Resin Solution 2 | 74.8 | | | | |
| Silicone Resin Solution 3 | | | 786 | 786 | |
| Silicone Resin Solution 4 | | | 17.5 | 17.5 | |
| Polymerization Catalyst | 13.0 | | 6.99 | 7.24 | |
| Antioxidant | | | 0.30 | 0.29 | |
| Coating Auxiliary | 0.24 | 0.48 | 1.20 | 1.16 | 2.00 |
| Agent | | | | | |
| Acrylic Resin Solution | | 88.7 | | | 358 |
| Acrylic Monomer | | 39.0 | | | 112 |
| Solution | | | | | |
| Photopolymerization | | 0.44 | | | 11.2 |
| Initiator | | | | | |
| Polymerization | | 0.05 | | | 0.15 |
| Inhibitor | | | | | |
| Organic Solvent 1 | 245 | 326 | | | |
| Organic Solvent 2 | 325 | 263 | 20.6 | 13.8 | 203 |
| Organic Solvent 3 | | 87.9 | | | |
| Thickness after Drying | 2.0 | 2.0 | 34 | 34 | 35 |
| Optical Density | 4.5 | 4.5 | 1.1 | 1.1 | 1.0 |

Black dispersion (GB4016, manufactured by Sanyo color Works Ltd., the following composition)
Black pigment (carbon black): 25.0 mass %
Dispersing auxiliary agent: 9.5 mass %
Dispersant (propylene glycol monomethyl ether acetate): 65.5 mass %

White dispersion (FP White B422, manufactured by Sanyo color Works Ltd., the following composition)
White pigment (titanium dioxide): 70.0 mass %
Dispersing auxiliary agent: 3.5 mass %
Dispersant (methyl ethyl ketone): 26.5 mass %

Silicone resin solution 1 (KR300, manufactured by Shin-Etsu Chemical Co., Ltd., the following composition)
Xylene solution of silicone resin (solid content: 50 mass %)

Silicone resin solution 2 (KR311, manufactured by Shin-Etsu Chemical Co., Ltd., the following composition)
Xylene solution of silicone resin (solid content: 60 mass %)

Silicone resin solution 3 (KR251, manufactured by Shin-Etsu Chemical Co., Ltd the following composition)
Xylene solution of silicone resin (solid content: 20 mass %)

Silicone resin solution 4 (X-40-9246, manufactured by Shin-Etsu Chemical Co., Ltd., the following composition)
Silicone resin (solid content: 100 mass %)

Polymerization catalyst (D-15, manufactured by Shin-Etsu Chemical Co., Ltd., the following composition)
Xylene solution of a zinc-containing catalyst (solid content: 50 mass %)

Antioxidant (IRGAFOS 168, manufactured by BASF SE, the following compound)

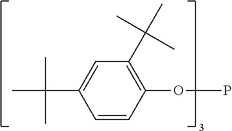

Coating auxiliary agent (MEGAFAC F-780F, manufactured by DIC Corporation, the following composition)
Surfactant: 30 mass %
Methyl ethyl ketone: 70 mass %

Acrylic resin solution (the following composition)
Random copolymer of benzyl methacrylate/methacrylic acid
(molar ratio: 78/22, weight average molecular weight: 38,000): 27 mass %
Propylene glycol monomethyl ether acetate: 73 mass %

Acrylic monomer solution (manufactured by Nippon Kayaku Co., Ltd., the following composition)
Dipentaerythritol hexaacrylate: 76 mass %
Propylene glycol monomethyl ether acetate: 24 mass %

Polymerization initiator (IRGACURE OXE 01, manufactured by BASF SE, the following compound)

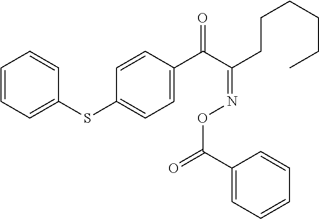 [SMILES: CCCCCC/C(=N/OC(=O)c1ccccc1)C(=O)c1ccc(Sc2ccccc2)cc1]

Polymerization inhibitor (phenothiazine, the following compound)

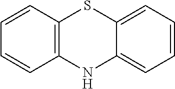 [SMILES: c1ccc2c(c1)Nc1ccccc1S2]

Organic solvent 1 (propylene glycol monomethyl ether acetate)
Organic solvent 2 (methyl ethyl ketone)
Organic solvent 3 (cyclohexanone)

<Preparation of Release Film>

The following release film was prepared for a temporary support with a release layer.

UNIPEEL TR6 (manufactured by Unitika Ltd.; an olefin-based release layer from which a matting agent protruded by 200 nm was formed on a PET film having a thickness of 75 μm)
6502 (manufactured by Lintec Corporation; a non-silicone-based release layer from which a matting agent protruded by 320 nm was formed on a PET film having a thickness of 50 μm)
CERAPEEL BLK (manufactured by Toray Advanced Film Co., Ltd.; a non-silicone-based release layer from which a matting agent protruded by 200 nm was formed on a PET film having a thickness of 50 μm)
HP-A5 (manufactured by Fujico Co., Ltd.; a non-silicone-based release layer from which a matting agent protruded by 400 nm was formed on a PET film having a thickness of 75 μm)
FILMBYNA NSD (manufactured by Fujimori Kogyo Co., Ltd.; a non-silicone-based release layer from which a matting agent protruded by 270 nm was formed on a PET film having a thickness of 50 μm)
TOYOBO ESTER FILM TN110 (manufactured by Toyobo Co., Ltd.; a silicone-based release layer from which a matting agent protruded by 320 nm was formed on a PET film having a thickness of 75 μm)

<Preparation of Protective Film>

Next, the following protective film was prepared.

ALPHAN E-501 (manufactured by Oji F-Tex Co, Ltd., a polypropylene film having a thickness of 12 μm)

<Preparation of Colorant Layer (Transfer Layer Including Light Shielding Layer and White Layer) on Temporary Support>

Using an E-type coating machine, the black colorant solution 1 or 2 shown in Table 1 was applied to the release layer on the temporary support to form a light shielding layer thereon such that the thickness thereof after drying was 2.0 μm, and was dried.

Any one of the white colorant solutions 1 to 3 shown in Table 1 was applied to the light shielding layer to form a white layer thereon such that the thickness thereof after drying was 32.0 μm, and was dried.

The protective film was pressure-bonded to the white layer. As a result, a transfer material having a temporary support width of 260 mm, a transfer layer width of 240 mm, and a coating length of 20 m was prepared. The specific layer configurations are shown in Table 2 below. The obtained transfer material was used as a transfer material of Examples 1 to 8 and Comparative Example 2.

<Preparation of Substrate with Transfer Layer Using Film Transfer Method>

Tempered glass (300 mm×400 mm×0.7 mm) on which the opening 8 (15 mmφ) was formed as shown in FIG. 2 was cleaned with a rotary brush having nylon bristles while being sprayed with a glass cleaning solution at an adjusted temperature of 25° C. by showering for 20 seconds. This glass substrate was pre-heated by a substrate pre-heating device at 90° C. for 2 minutes.

Each of the transfer materials of Examples 1 to 8 and Comparative Example 2 was molded into a frame shape having a size corresponding to that of the four sides of the glass substrate and then was transferred to the glass substrate. The details will be described below.

The transfer material was punched such that the length of one side was 98 mm and the frame width was 10 mm. A PET sheet having a one side length of 120 mm and a thickness of 100 μm was prepared. An adhesive SK DYNE 1604 N (manufactured by Soken Chemical & Engineering Co., Ltd.) was applied to the center of the PET sheet such that the length of one side length was 90 mm, thereby forming an adhesive film. The temporary support side of the punched transfer material was bonded to the PET sheet. Separately, another PET sheet having a one side length of 70 mm and a thickness of 50 μm was prepared and then bonded to the above laminate such that the adhesive of the adhesive film did not have an effect on a region of the PET sheet outside of a portion where the transfer material is bonded. Next, the protective film was removed from the transfer material. Next, a glass substrate having a one side length of 100 mm was prepared. Using a laminator, the transfer material was transferred to the glass substrate together with the adhesive film from the side of the PET sheet where the transfer material was bonded. When the transfer material was transferred to the glass substrate, the temperature of the glass substrate was 40° C. Next, the temporary support was removed from the glass sheet together with the adhesive sheet.

In this way, the glass substrate with a transfer layer was obtained.

<Preparation of Substrate with Transfer Layer>

Next, assuming ITO sputtering, the laminate was heated at 280° C. for 30 minutes. In this way, substrates with a transfer layer of Examples 1 to 8 and Comparative Example 2 in which the glass substrate, the white layer, and the light shielding layer were laminated in this order were obtained.

<Measurement of Peeling Strength>

(1) Step of Peeling Off Protective Film from Transfer Layer

The peeling strength between the protective film and the transfer layer (white layer) was measured using the following method. The results are shown in Table 2 below.

A glass substrate having a one side length of 100 mm was prepared. The temporary support side of the transfer material having a one side length of 90 mm was bonded to the glass substrate through double-sided adhesive tape No. 5610 (manufactured by Nitto Denko Corporation) such that the protective film faced air side. A part of the protective film was peeled off, and the peeling strength thereof was measured using a digital loading machine/tensile testing machine SV-55 (manufactured by IMDA-SS Corporation).

(2) Step of Transferring Transfer Layer to Transfer Target Substrate (Glass Substrate) and Peeling Off Temporary Support

The peeling strength between the transfer target substrate (glass substrate) and the transfer layer (white layer) was measured using the following method. The results are shown in Table 2 below.

A glass substrate having a one side length of 100 mm was prepared. The transfer material having a one side length of 90 mm was prepared. After the protective film was peeled off from the transfer material, the transfer material was laminated on the glass substrate at 40° C. such that the transfer layer faced the glass substrate. A part of the temporary support was peeled off from the laminated transfer material, and the peeling strength thereof was measured using a TENSILON universal testing machine RTG-1210 (manufactured by A&D Co., Ltd.).

<Evaluation>

(Quality of Light Shielding Layer)

Regarding each of the substrates with a transfer layer of Examples 1 to 8 and Comparative Example 2, the quality of the light shielding layer was evaluated by visual inspection after the colorant layer was transferred to the substrate and the protective film and the release layer were peeled off.

A case where the transfer characteristics of the colorant layer were superior, the peeling of the colorant layer did not occur, and the release layer did not remain on the colorant layer side (a developing step was not necessary) was evaluated as “Good”.

On the other hand, in any one of a case where there was a problem in the transfer characteristics of the colorant layer, a case where the colorant layer was peeled off, and a case where the release layer remained on the colorant layer side (a developing step was necessary), there was a problem in practice.

The evaluation results are shown in Table 2 below.

(Optical Density)

Regarding each of the substrates with a transfer layer of Examples 1 to 8 and Comparative Example 2 prepared as described above, the optical density of the laminate including the transfer layer (the light shielding layer and the white layer) and the transfer target substrate was measured using BMT-1 (manufactured by Sakata Inx Corporation).

The evaluation results are shown in Table 2 below.

(Surface Resistance on Light Shielding Layer)

The surface resistance on the light shielding layer of each of the substrates with a transfer layer of Examples 1 to 8 and Comparative Example 2 prepared as described above was measured using an ultrahigh resistance meter R8340A (manufactured by Advantest Corporation).

It was found that the surface resistance on the light shielding layer of each of the substrates with a transfer layer of Examples 1 to 8 and Comparative Example 2 was 1.0×10¹³Ω/□ or higher at 25° C.

(Surface Elementary Analysis)

In order to verify that the release layer did not remain on the light shielding layer of each of the substrates with a transfer layer of Examples 1 to 8 and Comparative Example 2 prepared as described above, elementary analysis was performed on the surface of the release layer in the state of the transfer material and the surface of the release layer after the peeling of the transfer layer using an X-ray photoelectron spectroscopic analyzer (AXIS-HSi, manufactured by Shimadzu Corporation).

The results are shown in Table 2 below.

In Example 1, O, N, and C were detected on the surface of the release layer in the state of the transfer material (before peeling), and O, N, C, and Si were detected on the surface of the transfer layer after the peeling of the transfer layer. This result shows that the release layer was present on the temporary support side after the peeling of the transfer layer.

As described below, in Comparative Example 1 not including the release layer, elementary analysis was performed on the surface of the temporary support in the state of the transfer material and the surface of the temporary support after the peeling of the transfer layer, and N and Si were detected on the surface of the temporary support after the peeling of the transfer layer. This result shows that the light shielding layer was also peeled off during the peeling of the temporary support.

### Comparative Example 1

A transfer material and a substrate with a transfer layer of Comparative Example 1 were prepared using the same method as in Example 1, except that the colorant layer (the transfer layer including the light shielding layer and the white layer) was formed on the temporary support (PET on the side of UNIPEEL TR6 where the release layer was not present was used) not including the release layer without using the release film.

Regarding the transfer material and the substrate with a transfer layer prepared as described above, the measurement of the peeling strength and the evaluation of the substrate with a transfer layer were performed using the same method as in Example 1. The obtained results are shown in Table 2 below.

In Table 2, the optical densities of the transfer layer and the transfer target substrate of Comparative Example 1 imply that portions having a low optical density were formed due to the peeling of the light shielding layer.

### Comparative Examples 3 and 5

### Preparation of Temporary Support with Thermoplastic Resin Layer and Interlayer

Using the following method, a thermoplastic resin layer and an interlayer were formed on the temporary support.

Using a slit-shaped nozzle, a thermoplastic resin layer-forming coating solution prepared according to the following Formula H1 was applied to a polyethylene terephthalate film temporary support having a thickness of 75 μm and was dried. Next, an interlayer-forming coating solution prepared according to the Formula P1 was applied and dried.

(Thermoplastic Resin Layer-Forming Coating Solution: Formula H1)
Methanol: 11.1 parts by mass
Propylene glycol monomethyl ether acetate: 6.36 parts by mass
Methyl ethyl ketone: 52.4 parts by mass
Copolymer of methyl methacrylate/2-ethyl hexyl acrylate/benzyl methacrylate/methacrylic acid (copolymerization composition ratio (molar ratio)=55/11.7/4.5/28.8, molecular weight=100,000, Tg≈70° C.): 5.83 parts by mass
Copolymer of styrene/acrylic acid (copolymerization composition ratio (molar ratio)=63/37, weight average molecular weight=10,000, Tg≈100° C.): 13.6 parts by mass
Monomer 1 (trade name: BPE-500, manufactured by Shin-Nakamura Chemical Co., Ltd.): 9.1 parts by mass
Coating auxiliary agent: 0.54 parts by mass

After the removal of the solvent, the viscosity of the thermoplastic resin layer-forming coating solution H1 at 120° C. was 1500 Pa·sec.

(Interlayer-Forming Coating Solution: Formula P1)
Polyvinyl alcohol: 32.2 parts by mass
   (trade name: PVA205, manufactured by Kuraray Co., Ltd., saponification degree=88%, polymerization degree=550)
Polyvinyl pyrrolidone: 14.9 parts by mass
   (trade name: K-30, manufactured by ISP Japan Ltd.)
Distilled water: 524 parts by mass
Methanol: 429 parts by mass

<Preparation of Transfer Material>

A transfer material and a substrate with a transfer layer of Comparative Example 3 were prepared using the same method as in Example 1, except that the colorant layer was formed on the interlayer of the obtained temporary support with the thermoplastic resin layer and the interlayer without using the release film.

In addition, a transfer material and a substrate with a transfer layer of Comparative Example 5 were prepared using the same method as in Comparative Example 3, except that the black colorant solution and the white colorant solution were changed.

Regarding the transfer material and the substrate with a transfer layer prepared as described above, the measurement of the peeling strength and the evaluation of the substrate with a transfer layer were performed using the same method as in Example 1. The obtained results are shown in Table 2 below.

### Comparative Example 4

A transfer material and a substrate with a transfer layer of Comparative Example 4 were prepared using the same method as in Example 1, except that the protective film was not provided.

Regarding the transfer material and the substrate with a transfer layer prepared as described above, the measurement of the peeling strength and the evaluation of the substrate with a transfer layer were performed using the same method as in Example 1. The obtained results are shown in Table 2 below.

TABLE 2

| | | | Release Layer | | | | | |
|---|---|---|---|---|---|---|---|---|
| | | | | | | Height | | |
| | | | | | Element | [nm] of | | |
| | | | | | on Surface | Protrusion | | |
| | | | | | of Release | of Matting | Transfer Layer | |
| | | | | | Layer (or | Agent | (Colorant layer) | |
| | | | | | Temporary | from | Light | |
| | Temporary Support | | | | Support) | Release | Shielding | White |
| | Composition | Kind | Kind | Polymer | (ESCA) | Layer | Layer | Layer |
| Example 1 | PET | UNIPEEL TR6 | | Olefin-Based | O, N, C | 200 | Black | White |
| | | | | | | | Colorant | Colorant |
| | | | | | | | Solution 1 | Solution 1 |
| Example 2 | PET | 6502 | | Non-Silicone-Based | O, N, C | 320 | Black | White |
| | | | | | | | Colorant | Colorant |
| | | | | | | | Solution 1 | Solution 1 |
| Example 3 | PET | CERAPEEL BLK | | Silicone-Based | O, C, Si | 200 | Black | White |
| | | | | | | | Colorant | Colorant |
| | | | | | | | Solution 1 | Solution 1 |
| Example 4 | PET | HP-A5 | | Non-Silicone-Based | O, N, C | 400 | Black | White |
| | | | | | | | Colorant | Colorant |
| | | | | | | | Solution 1 | Solution 1 |
| Example 5 | PET | FILMBYNA NSD | | Non-Silicone-Based | O, N, C | 270 | Black | White |
| | | | | | | | Colorant | Colorant |
| | | | | | | | Solution 1 | Solution 1 |
| Example 7 | PET | UNIPEEL TR6 | | Olefin-Based | O, N, C | 200 | Black | White |
| | | | | | | | Colorant | Colorant |
| | | | | | | | Solution 1 | Solution 2 |
| Example 8 | PET | UNIPEEL TR6 | | Olefin-Based | O, N, C | 200 | Black | White |
| | | | | | | | Colorant | Colorant |
| | | | | | | | Solution 2 | Solution 3 |
| Comparative | PET | UNIPEEL | None | — | O, C | — | Black | White |
| Example 1 | | TR6 | | | | | Colorant | Colorant |
| | | (Opposite | | | | | Solution 1 | Solution 1 |
| | | Side of | | | | | | |
| | | Peeling | | | | | | |
| | | Layer was | | | | | | |
| | | Used) | | | | | | |
| Comparative | PET | TOYOBO ESTER FILM | | Silicone-Based | O, N, C | 320 | Black | White |
| Example 2 | | TN110 | | | | | Colorant | Colorant |
| | | | | | | | Solution 1 | Solution 1 |
| Comparative | PET | Temporary | Thermoplastic | Thermoplastic | O, N, C | — | Black | White |
| Example 3 | | Support | Resin Layer | Resin Layer: | | | Colorant | Colorant |
| | | | and Interlayer | Acrylic | | | Solution 2 | Solution 3 |
| | | | | Interlayer: | | | | |
| | | | | PVA-Based | | | | |
| Comparative | PET | UNIPEEL TR6 | | Olefin-Based | O, N, C | 200 | Black | White |
| Example 4 | | | | | | | Colorant | Colorant |
| | | | | | | | Solution 1 | Solution 1 |
| Comparative | PET | Temporary | Thermoplastic | Thermoplastic | O, N, C | — | Black | White |
| Example 5 | | Support | Resin Layer | Resin Layer: | | | Colorant | Colorant |
| | | | and Interlayer | Acrylic | | | Solution 1 | Solution 1 |
| | | | | Interlayer: | | | | |
| | | | | PVA-Based | | | | |

| | | | | Peeling Strength | | | |
|---|---|---|---|---|---|---|---|
| | | | | [mN/m] of | | | |
| | | | | Temporary Support | | | |
| | | | | Between | | | |
| | | | | Laminate | | | |
| | | | | including | | | |
| | | | | Release | | Evaluation | |
| | | | | Layer and | | | Element |
| | | | | Temporary | | | on |
| | | | | Support | | | Surface |
| | | | | and Light | | Optical | of |
| | | Peeling Strength | | Shielding | | Densities | Release |
| | | [mN/m] of | | Layer (or | | of | Layer |
| | | Protective Film | | between | | Transfer | After |
| | | Whether | Between | Temporary | | Layer | Peeling |
| | | of not | Protective | Support | Quality of | and | of |
| | | Peeling of | Film and | and Light | Light | Transfer | Transfer |
| | Protective | Protective | White | Shielding | Shielding | Target | Layer |
| | Film | Film | Layer | Layer) | Layer | Substrate | (ESCA) |
| Example 1 | E-501 | Possible | 39.2 | 76.4 | Good | 5.5 | O, N, C, |
| | | | | | | | Si |
| Example 2 | E-501 | Possible | 40.2 | 142.1 | Good | 5.5 | O, N, C, |
| | | | | | | | Si |
| Example 3 | E-501 | Possible | 39.2 | 44.1 | Good | 5.5 | O, C, Si |
| Example 4 | E-501 | Possible | 39.2 | 117.6 | Good | 5.5 | O, N, C, |
| | | | | | | | Si |
| Example 5 | E-501 | Possible | 41.2 | 69.6 | Good | 5.5 | O, N, C, |
| | | | | | | | Si |
| Example 7 | E-501 | Possible | 40.2 | 83.3 | Good | 5.5 | O, N, C, |
| | | | | | | | Si |
| Example 8 | E-501 | Possible | 44.1 | 98.0 | Good | 5.5 | O, N, C |
| Comparative | E-501 | Possible | 39.2 | 436.1 | Peeling Stain | 5.0 to | O, N, C, |
| Example 1 | | | | | Observed | 5.5* | Si* |
| Comparative | E-501 | Impossible | — | — | — | — | — |
| Example 2 | | | | | | | |
| Comparative | E-501 | Possible | 44.1 | — | Residue of | — | — |
| Example 3 | | | | | Thermoplastic | | |
| | | | | | Resin Layer | | |
| | | | | | and Interlayer | | |
| | | | | | Observed | | |
| Comparative | None | — | Not Usable | — | — | — | — |
| Example 4 | | | because | | | | |
| | | | Transfer | | | | |
| | | | Layer was | | | | |
| | | | Adhered to | | | | |
| | | | Side of | | | | |
| | | | Temporary | | | | |
| | | | Support | | | | |
| | | | Opposite | | | | |
| | | | Coated | | | | |
| | | | Surface | | | | |
| Comparative | E-501 | Possible | 39.2 | — | Residue of | — | — |
| Example 5 | | | | | Thermoplastic | | |
| | | | | | Resin Layer | | |
| | | | | | and Interlayer | | |
| | | | | | Observed | | |

It was found from Table 2 that, in the transfer materials of Examples 1 to 8, the transfer characteristics of the colorant layer were superior; when the temporary support was peeled off from the substrate (glass substrate) after the transfer layer was transferred to the substrate, the colorant layer was not peeled off and the release layer did not remain on the colorant layer side (the release layer was not adhered to the transfer layer side, and the temporary support and the release layer were peeled off together). When a portion of the release layer remains on the transfer layer (when a portion of the release layer remains on the surface of the transfer layer without being peeled off from the transfer layer), a step (for example, developing step) of removing this remaining portion is necessary. On the other hand, according to the transfer materials of Examples 1 to 8, the remaining of a part of the release layer was suppressed. Therefore, a step of removing this remaining portion was not necessary.

On the other hand, it was found from the results of Comparative Example 1 that, when the transfer material in which the peeling strength between the transfer material and the temporary support (between the temporary support and the light shielding layer) exceeds a predetermined upper limit is used, the light shielding layer is peeled off from the white layer during the peeling of the temporary support.

It was found from the results of Comparative Example 2 that, when the transfer material in which the peeling strength between the release layer and the transfer layer (light shielding layer) is lower than that between the protective film and the transfer layer (white layer) is used, the white layer is adhered to the protective film, and desired transfer cannot be performed.

It was found from the results of Comparative Examples 3 and 5 that, when the transfer material in which the peeling strength between the temporary support and the release layer is lower than that between the release layer and the transfer layer (light shielding layer) is used, the release layer remains on the light shielding layer during the peeling of the temporary support (a developing step is necessary).

It was found from the results of Comparative Example 4 that, when the protective film is not used (the protective film is not provided), the white layer is adhered to a non-coated surface of the temporary support, and desired transfer cannot be performed. Specifically, the protective film is not present; therefore, when the transfer material of Comparative Example 4 has a roll shape, the white layer transferred to the transfer target substrate is in contact with the temporary support. Therefore, in a stage before transfer, the surface of the white layer is likely to be affected by external factors. Accordingly, the transfer of the transfer material of Comparative Example 4 to the transfer target substrate is poor.

### Example 101

### Preparation of Touch Panel

<<Formation of First Transparent Electrode Pattern>>

<Formation of Transparent Electrode Layer>

Each of the substrates with a transfer layer of Examples 1 to 8 was put into a vacuum chamber. Next, using an ITO target (indium:tin=95:5 (molar ratio)) having a SnO₂ content ratio of 10 mass %, an ITO thin film having a thickness of 40 nm was formed by DC magnetron sputtering (conditions: substrate temperature: 250° C., argon pressure: 0.13 Pa, oxygen pressure: 0.01 Pa). As a result, a front surface plate (front surface plate A) on which transparent electrode layer was formed was obtained. The surface resistance of the ITO thin film was 80 Ω/□.

<Preparation of Transfer Film E1 for Etching>

A transfer film E1 for etching including the temporary support, the thermoplastic resin layer, the interlayer (oxygen barrier film), a photocurable resin layer for etching, and the protective film was obtained using the same method as the method for preparing the transfer material of Comparative Example 5, except that: the black colorant solution 1 was changed to a photocurable resin layer for etching-forming coating solution prepared according to the following Formula E1; and the white colorant solution 1 was not used. The thickness of the photocurable resin layer for etching was 2.0 μm.

(Photocurable Resin Layer for Etching-Forming Coating Solution: Formula E1)
Copolymer of methyl methacrylate/styrene/methacrylic acid (copolymer composition (mass %): 31/40/29, mass average molecular weight: 60,000, acid value: 163 mg/KOH/g): 16 parts by mass
Monomer 1 (trade name: BPE-500, manufactured by Shin-Nakamura Chemical Co., Ltd.): 5.6 parts by mass
Adduct of hexamethylene diisocyanate with 0.5 mol of tetramethylene oxide monomethacrylate: 7 parts by mass
Cyclohexane dimethanol monoacrylate as a compound having one polymerizable group in the molecules: 2.8 parts by mass
2-chloro-N-butyl acridone: 0.42 parts by mass
2,2-bis(o-chlorophenyl)-4,4′,5,5′-tetraphenyl bimidazole: 2.17 parts by mass
Leuco crystal violet: 0.26 parts by mass
Phenothiazine: 0.013 parts by mass
Surfactant (trade name: MEGAFAC F-780F, manufactured by D1C Corporation): 0.03 parts by mass
Methyl ethyl ketone: 40 parts by mass
1-methoxy-2-propanol: 20 parts by mass
<Formation of First Transparent Electrode Pattern>

The front surface plate A was cleaned, and the transfer film E1 for etching from which the protective film was removed was laminated thereon (substrate temperature: 130° C., rubber roller temperature: 120° C., linear pressure: 100 N/cm, transport speed: 2.2 m/min). After the temporary support was removed, the distance between an exposure mask (quartz exposure mask having a transparent electrode pattern) surface and the photocurable resin layer for etching was set to 200 and the pattern was exposed at an exposure rate of 50 mJ/cm² (i-ray).

Next, the obtained laminate was treated with a triethanolamine developer (containing 30 mass % of triethanolamine; a solution obtained by diluting T-PD2 (trade name, manufactured by Fujifilm Corporation) to 10 times with pure water) at 25° C. for 100 seconds and was treated with a surfactant-containing cleaning solution (a solution obtained by diluting T-SD3 (trade name, manufactured by Fujifilm Corporation) to 10 times with pure water) at 33° C. for 20 seconds, and a residue of the thermoplastic resin layer and the interlayer was removed with a rotary brush and an ultrasonic cleaning nozzle. Next, the laminate was post-baked at 130° C. for 30 minutes. As a result, a front surface plate (front surface plate B) on which the white layer, the light shielding layer, the transparent electrode layer, and the photocurable resin layer pattern for etching were formed was obtained.

The front surface plate B was dipped in an etching bath into which an ITO etchant (aqueous solution containing hydrochloric acid and potassium chloride; liquid temperature: 30° C.) was put and was treated for 100 seconds such that the transparent electrode layer in an exposed region not covered with the photocurable resin layer for etching was removed by dissolving. In this way, a front surface plate (front surface plate C) including the transparent electrode layer pattern on which the white layer, the light shielding layer, and the photocurable resin layer pattern for etching were formed was obtained.

Next, the front surface plate C was dipped in a resist peeling bath into which a resist peeling solution (N-methyl-2-pyrrolidone, monoethanolamine, surfactant (trade name: SURFYNOL 465, manufactured by Air Products and Chemicals Inc., liquid temperature: 45° C.) was put and was treated for 200 seconds such that the photocurable resin layer for etching was removed. In this way, a front surface plate (front surface plate D) including the white layer, the light shielding layer, and the first transparent electrode pattern (refer to FIG. 1A), which was provided on both regions of a non-contact surface of the front surface plate and a non-contact surface of the light shielding layer, was obtained.

<<Formation of Insulating Layer>>

<Preparation of Insulating Layer-Forming Transfer Film W1>

An insulating layer-forming transfer film W1 including the temporary support, the thermoplastic resin layer, the interlayer (oxygen barrier film), an insulating layer-forming photocurable resin layer, and the protective film was obtained using the same method as the method for preparing the transfer material of Comparative Example 5, except that: the black colorant solution 1 was changed to an insulating layer-forming coating solution prepared according to the following Formula W1; and the white colorant solution 1 was not used. The thickness of the insulating layer-forming photocurable resin layer was 1.4 μm.

(Insulating Layer-Forming Coating Solution: Formula W1)
Binder 3 (a solution (solid content 45%) in which a glycidyl methacrylate adduct (d) of a copolymer of cyclohexyl methacrylate (a)/methyl methacrylate (b)/methacrylic acid (c) (composition (mass %): a/b/c/d=46/1/10/43, mass average molecular weight: 36,000, acid value: 66 mgKOH/g) was dissolved in 1-methoxy-2-propanol and methyl ethyl ketone): 12.5 parts by mass
Solution in which DPHA (dipentaerythritol hexaacrylate, manufactured by Nippon Kayaku Co., Ltd.) was dissolved in propylene glycol monomethyl ether acetate (76 mass %): 1.4 parts by mass
Urethane monomer (trade name: NK OLIGO UA-32P, manufactured by Shin-Nakamura Chemical Co., Ltd., non-volatile content: 75%: propylene glycol monomethyl ether acetate: 25%): 0.68 parts by mass
Tripentaerythritol octaacrylate (trade name: V #802, manufactured by Osaka Organic Chemical Industry Ltd.): 1.8 parts by mass
Diethylthioxanthone: 0.17 parts by mass
2-(dimethylamino)-2-[(4-methylphenyl)methyl]-1-[4-(4-morpholinyl)phenyl]-1-butanone (trade name: IRGACURE 379, manufactured by BASF SE): 0.17 parts by mass
Dispersant (trade name: SOLSPERSE 20000, manufacture by Avecia): 0.19 parts by mass
Surfactant (trade name: MEGAFAC F-780F, manufactured by DIC Corporation): 0.05 parts by mass
Methyl ethyl ketone: 23.3 parts by mass
MMPGAc (manufactured by Daicel Corporation): 59.8 parts by mass

After the removal of the solvent, the viscosity of the insulating layer-forming coating solution W1 at 100° C. was 4000 Pa·sec.

The front surface plate D was cleaned, and the insulating layer-forming transfer film W1 from which the protective film was removed was laminated thereon (substrate temperature: 100° C., rubber roller temperature: 120° C., linear pressure: 100 N/cm, transport speed: 2.3 m/min). After the temporary support was removed, the distance between an exposure mask (quartz exposure mask having an insulating layer pattern) surface and the insulating layer-forming photocurable resin layer was set to 100 μm and the pattern was exposed at an exposure rate of 30 mJ/cm² (i-ray).

Next, the laminate was treated with a triethanolamine developer (containing 30 mass % of triethanolamine; a solution obtained by diluting T-PD2 (trade name, manufactured by Fujifilm Corporation) to 10 times with pure water) at 33° C. for 60 seconds, was treated with a sodium carbonate/sodium bicarbonate developer (a solution obtained by diluting T-CD1 (trade name, manufactured by Fujifilm Corporation) to 5 times with pure water) at 25° C. for 50 seconds, was treated with a surfactant-containing cleaning solution (a solution obtained by diluting T-SD3 (trade name, manufactured by Fujifilm Corporation) to 10 times with pure water) at 33° C. for 20 seconds, and a residue was removed with a rotary brush and an ultrasonic cleaning nozzle. Next, the laminate was post-baked at 230° C. for 60 minutes. As a result, a front surface plate (front surface plate E) on which the white layer, the light shielding layer, the first transparent electrode pattern, and the insulating layer pattern were formed was obtained.

<<Formation of Second Transparent Electrode Pattern>

<Formation of Transparent Electrode Layer>

As in the formation of the first transparent electrode pattern, an ITO thin film having a thickness of 80 nm was formed by performing DC magnetron sputtering (conditions: substrate temperature: 50° C., argon pressure: 0.13 Pa, oxygen pressure: 0.01 Pa) on the front surface plate E. As a result, a front surface plate (front surface plate F) on which the white layer, the light shielding layer, the first transparent electrode pattern, the insulating layer pattern, and the transparent electrode layer were formed was obtained. The surface resistance of the ITO thin film was 110 Ω/□.

By using the transfer film E1 for etching as in the formation of the first transparent electrode pattern, a front surface plate (front surface plate G) on which the white layer, the light shielding layer, the first transparent electrode pattern, the insulating layer pattern, the transparent electrode layer, and the photocurable resin layer pattern for etching were formed was obtained. Post baking was performed at 130° C. for 30 minutes.

Further, as in the formation of the first transparent electrode pattern, the front surface substrate was etched (30° C., 50 seconds) to remove the photocurable resin layer for etching (45° C., 200 seconds). In this way, a front surface plate (front surface plate H) including the white layer, the light shielding layer, the first transparent electrode pattern, the insulating layer pattern, and the second transparent electrode pattern (refer to FIG. 1A), which was provided on both regions of a non-contact surface of the front surface plate and a non-contact surface of the light shielding layer, was obtained.

<<Formation of Another Conductive Element Different from First and Second Transparent Electrode Pattern>>

As in the formation of the first and second transparent electrode patterns, an aluminum (Al) thin film having a thickness of 200 nm was formed by performing DC magnetron sputtering on the front surface plate H. As a result, a front surface plate (front surface plate I) was obtained.

By using the transfer film E1 for etching as in the formation of the first and second transparent electrode patterns, a front surface plate (front surface plate J) on which the white layer, the light shielding layer, the first transparent electrode pattern, the insulating layer pattern, the second transparent electrode pattern, the aluminum thin film, and the photocurable resin layer pattern for etching were formed was obtained (post baking; 130° C., 30 minutes).

Further, as in the formation of the first transparent electrode pattern, the front surface substrate was etched (30° C., 50 seconds) to remove the photocurable resin layer for etching (45° C., 200 seconds). As a result, a front surface plate (front surface plate K) on which the white layer, the light shielding layer, the first transparent electrode pattern, the insulating layer pattern, the second transparent electrode pattern, and the conductive element were formed was obtained.

<<Formation of Transparent Protective Layer>>

As in the formation of the insulating layer, the insulating layer-forming transfer film W1 from which the protective film was removed was laminated on the front surface plate K. Next, after the temporary support was removed, the front surface plate was exposed at an exposure rate of 50 mJ/cm² (i-ray) without using an exposure mask, was developed, was post-exposed (1000 mJ/cm²), and was post-baked. As a result, a front surface plate (front surface plate L; refer to FIG. 1A) in which the insulating layer (transparent protective layer) was laminated so as to cover all of the white layer, the light shielding layer, the first transparent electrode pattern, the insulating layer pattern, the second transparent electrode pattern, and the conductive element was obtained. The obtained front surface plate L was used as touch panels of Examples 1 to 8.

<Preparation of Information Display Device>

The front surface plate L (touch panels of Examples 1 to 8) was bonded to an liquid display element which is manufactured using the method disclosed in JP2009-47936A. Each of information display devices of Examples 1 to 8 including the touch panel as a component was prepared using a well-known method.

<<Overall Evaluation of Front Surface Plate and Information Display Device>>

The front surface plate L (touch panels of Examples 1 to 8) was easily cleaned without contamination of an opening and a back surface thereof, and other members were also not contaminated.

In addition, in the white layer, no pinholes were formed, and there were no problems in whiteness and uniformity. In the light shielding layer, no pinholes were formed, and light shielding characteristics were superior.

In addition, there were no problems in the conductivity of the first transparent electrode pattern, the second transparent electrode pattern, and the conductive element. In addition, conductivity was established between the first transparent electrode pattern and the second electrode pattern.

Further, the transparent protective layer did not have defects such as bubbles, and an information display device having superior display characteristics was obtained.

### EXPLANATION OF REFERENCES

1: front surface plate
1a: non-contact surface
2: transfer layer (decorative material)
2a: white layer
2b: light shielding layer
3: first transparent electrode pattern
4: second electrode pattern
5: insulating layer
6: conductive element
7: transparent protective layer
8: opening
10: touch panel
11: temporary support
12: release layer
13: protective film
20 transfer material
30: blade
101a: glass substrate
101b: film substrate

What is claimed is:

1. A transfer material comprising a temporary support, a release layer, a transfer layer, and a protective film in this order,
wherein when the protective film is peeled off from the transfer material, the protective film is peeled off from the transfer layer and the transfer layer remains on the release layer side, and
when the temporary support is peeled off after the transfer layer is transferred to a transfer target substrate formed of glass or to a transfer target substrate formed of a film selected from triacetyl cellulose, polyethylene terephthalate, polycarbonate, and a cycloolefin polymer, the release layer is peeled off together with the temporary support.

2. The transfer material according to claim 1,
wherein when the protective film is peeled off from the transfer material, a peeling strength between the protective film and the transfer layer is 10 mN/m to 200 mN/m.

3. The transfer material according to claim 1,
wherein when a laminate including the release layer and the temporary support is peeled off from the transfer layer which is transferred to the transfer target substrate, a peeling strength is 40 mN/m to 400 mN/m.

4. The transfer material according to claim 1,
wherein the release layer contains a matting agent, and
the matting agent protrudes from the release layer by 150 nm to 500 nm.

5. The transfer material according to claim 1,
wherein the release layer contains a polymer selected from a polycondensate of alkyl diol and bifunctional or higher isocyanate, a silicone resin, and an olefin resin.

6. The transfer material according to claim 1,
wherein the release layer contains a polymer selected from a polycondensate of alkyl diol and bifunctional or higher isocyanate and an olefin resin.

7. The transfer material according to claim 1,
wherein the transfer layer includes at least one layer, and
at least one layer of the transfer layer contains a binder resin and at least one of a pigment and a dye.

8. The transfer material according to claim 1,
wherein the transfer layer includes at least two layers,
at least one layer of the transfer layer contains a binder resin and at least one of a pigment and a dye, and
another layer of the transfer layer contains a binder resin.

9. The transfer material according to claim 7,
wherein the binder resin contained in the at least one layer of the transfer layer has a siloxane bond.

10. The transfer material according to claim 7,
wherein at least one layer of the transfer layer contains, as the pigment or the dye, at least one pigment or dye selected from a black pigment, a black dye, and a white pigment.

11. The transfer material according to claim 1,
wherein the transfer layer includes at least two layers,
a layer of the transfer layer adjacent to the release layer contains at least one pigment or dye selected from a black pigment and a black dye, and
a layer of the transfer layer adjacent to the protective film contains a white pigment.

12. The transfer material according to claim 1,
wherein the transfer layer includes at least two layers, and
optical densities of the layers of the transfer layer increase toward the release layer.

13. The transfer material according to claim 1,
wherein the transfer layer includes at least two layers, and
an optical density of a layer of the transfer layer adjacent to the release layer is 1.0 to 6.0.

14. The transfer material according to claim 1,
wherein the transfer layer includes at least two layers, and
a thickness of a layer of the transfer layer adjacent to the release layer is 0.5 μm to 3.0 μm.

15. The transfer material according to claim 1,
wherein the transfer layer includes at least two layers, and
a thickness of a layer of the transfer layer adjacent to the protective film layer is 5.0 μm to 50.0 μm.

16. The transfer material according to claim 1,
wherein the temporary support contains a resin selected from a polyester resin, a triacyl cellulose resin, and a cycloolefin resin.

17. The transfer material according to claim 1,
wherein the protective film is a polyolefin film.

18. The transfer material according to claim 1,
wherein the transfer target substrate is formed of glass.

19. The transfer material according to claim 1,
wherein the transfer target substrate is formed of a cycloolefin polymer film.

20. A method for manufacturing the transfer material according to claim 1, the method comprising:
(1) preparing the temporary support with the release layer;
(2) forming the transfer layer on the release layer side of the temporary support; and
(3) bonding the protective film to the transfer layer side.

21. A method for manufacturing a substrate with a transfer layer using the transfer material according to claim 1, the method comprising:
(11) peeling off the protective film from the transfer material;
(12) transferring the transfer layer side of the transfer material to the transfer target substrate formed of glass or to the transfer target substrate formed of a film selected from triacetyl cellulose, polyethylene terephthalate, polycarbonate, and a cycloolefin polymer; and
(13) simultaneously peeling off the release layer and the temporary support from the transfer layer.

22. The method for manufacturing a substrate with a transfer layer according to claim 21,
wherein when the transfer layer is transferred to the transfer target substrate, a temperature of the transfer target substrate is 40° C. to 150° C.

23. A substrate with a transfer layer which is manufactured using the method for manufacturing a substrate with a transfer layer according to claim 21.

24. The substrate with a transfer layer according to claim 23,
wherein a surface resistance of the transfer layer at 25° C. is 1.0×10¹⁰Ω/□ or higher.

25. A method for manufacturing a touch panel using the substrate with a transfer layer according to claim 23, the method comprising:
(21) forming a conductive layer on the transfer layer side of the substrate with a transfer layer; and
(22) removing a part of the conductive layer to form an electrode pattern.

26. A touch panel comprising the substrate with a transfer layer according to claim 23.

27. An information display device comprising the touch panel according to claim 26.
